(19) United States
(12) Patent Application Publication
(10) Pub. No.: US 2024/0150019 A1
(43) Pub. Date: May 9, 2024

(54) SYSTEMS AND METHODS FOR REDUCING DYNAMIC LOADS EXPERIENCED BY AIRCRAFT CARGO DURING OPERATIONS

(71) Applicant: ZSM Holdings LLC, Dover, DE (US)

(72) Inventor: Matteo Martegani, Boulder, CO (US)

(21) Appl. No.: 18/549,511

(22) PCT Filed: Mar. 10, 2022
(86) PCT No.: PCT/US2022/019854

§ 371 Date: Sep. 7, 2023

Related U.S. Application Data
(60) Provisional application No. 63/159,430, filed on Mar. 10, 2021.

(51) Int. Cl. B64D 9/00; F03D 13/40

(52) U.S. Cl. CPC B64D 9/003; F03D 13/401

(57) ABSTRACT

Systems to reduce the loads on highly flexible aircraft cargo, such as wind turbine blades, are disclosed. Such systems can be active and/or passive. Active systems can be in the form of open or closed loop active control systems comprising one or more sensors on the airframe and/or payload, actuators acting on the payload, and/or an electronic controller. Passive systems can include spring-and-damper suspensions, optionally combined with devices such as vibration absorbers, and can be controlled, for example, by the placement of payload fixtures and the degrees of constraint they impose on the payload.

### CROSS-REFERENCE TO RELATED APPLICATIONS

This application claims priority to and the benefit of U.S. Provisional Patent Application Ser. No. 63/159,430, entitled “SYSTEMS AND METHODS FOR REDUCING DYNAMIC LOADS EXPERIENCED BY AIRCRAFT CARGO DURING OPERATIONS,” filed Mar. 10, 2021, the contents of which is incorporated by reference herein in its entirety.

### FIELD

The present disclosure generally relates to systems and methods for reducing dynamic loads experienced by a payload carried in the cargo hold of an aircraft or other transport vehicle.

### BACKGROUND

Increases in global demand for wind energy has catalyzed the development of larger, better-performing wind turbines, as turbines with larger rotor diameters generally capture more wind energy. As turbines continue to improve, wind farm sites in previously undeveloped or underdeveloped locations become viable both onshore and offshore, including existing sites where older turbines need replacement.

A limiting factor to allow for the revitalization of old sites and development of new sites is transporting the wind turbines, and related equipment, to the sites. Wind turbine blades are difficult to transport long distances due to the terrestrial limitations of existing air vehicles and roadway infrastructures. Whether onshore or offshore, the road vehicle or ship options for transporting such equipment has become more limited, particularly as the size of wind turbines increase. The very long lengths of wind turbine blades (some are presently over 100 meters long and over 5 meters in diameter) make conventional transportation by train, truck, or ship very difficult. Unfortunately, the solution is not as simple as making vehicles longer and/or larger; a variety of complications present themselves as vehicles are made longer and/or larger, including but not limited to: load balancing of the vehicle, the payload, and/or the two with respect to each other; handling, maneuverability, and control of the vehicle; and other complications apparent to those skilled in the art.

Further, whether onshore or offshore, delivery of parts can be slow and severely limited by the accessibility of the site. Wind farm sites are often remote, and thus not near suitable transportation infrastructure, and new sites are often without any existing transportation infrastructure, thus requiring new construction and special equipment. Ultimately, transportation logistics become cost prohibitive, resulting in a literal and figurative roadblock to further advancing the use of wind energy on a global scale.

Aerial transportation is one potential solution to moving large wind turbine blades. This requires a bespoke aerial vehicle design, capable of accommodating objects with the unique shape and mass characteristics of wind turbine blades. Special techniques for handling this unconventional cargo developed concurrently with the vehicle can reduce the overall cost of blade transportation and improve the system's performance by other metrics such as volumetric efficiency of the vehicle. These techniques can position the cargo so as to use otherwise wasted space within the vehicle, and/or react the inertial loads of the cargo to the vehicle in a structurally efficient manner.

Aircraft in operation experience accelerations. Those accelerations are transferred to any payload carried in their cargo hold. Some payload items, such as wind turbine blades, may exhibit resonant frequencies within the frequency range of excitation applied to them during flight, landing, and/or ground operation of the aircraft. The payload may thus experience high loads due to enforced motions applied by the airframe through the payload fixtures, for example, because of accelerations experienced by the aircraft or other disturbances transferred to the payload from the airframe.

In order to protect the structural integrity of the payload, it would be desirable to reduce the loads experienced by the payload by reducing the dynamic response of the payload.

### SUMMARY

Certain examples of the present disclosure include systems and methods configured to manipulate one or more dynamic characteristics of the payload to, at least temporarily, alter the dynamic characteristic of the payload in at least a structural normal mode of vibration. Examples of the present disclosure relate to extremely large cargo aircraft capable of both carrying extremely long payloads and being able to takeoff and land at runways that are significantly shorter than those required by most, if not all, existing large aircraft. For purposes of the present disclosure, a large or long aircraft is considered an aircraft having a fuselage length from fuselage nose tip to fuselage tail tip that is at least approximately 60 meters long. The American Federal Aviation Administration (FAA) defines a large aircraft as any aircraft of more than 12,500 pounds maximum certificated takeoff weight, which can also be considered a large aircraft in the present context, but the focus of size is generally related to a length of the aircraft herein. One example of such an oversized payload capable of being transported using examples of this present disclosure are large wind turbine blades, which can be over 100 meters in length. Examples of the present disclosure enable a payload of such an extreme length to be transported within the cargo bay of an aircraft having a fuselage only slighter longer than the payload, while that aircraft can also takeoff and land at most existing commercial airports, as well as runways that are even smaller, for instance because they are built at a location for landing such cargo aircraft near a site where the cargo is to be used, such as a landing strip built as part of a wind farm.

According to at least one aspect of the present disclosure, a system for alleviating dynamic loads on a payload includes at least one payload-receiving fixture and a dynamic load reduction system. The at least one payload-receiving fixture is configured to receive a payload and couple the payload to an airframe within an interior cargo bay of an aircraft. The dynamic load reduction system includes at least one suspension element associated with at least one of the payload or the at least one payload-receiving fixture. The dynamic load reduction system is configured to alter at least one dynamic vibration characteristic of the payload when the payload is associated with the at least one payload-receiving fixture and coupled to the airframe such that a dynamic load exerted by the airframe on the payload is reduced.

In some embodiments, the at least one dynamic vibration characteristic can be one or more of a vibration frequency, a vibration mode shape, a vibration amplitude, or a vibration damping. The system can further include a payload configured to be received by the at least one payload-receiving fixture. The at least one payload-receiving fixture can include a plurality of payload-receiving fixtures placed with respect to the payload to minimize the dynamic load exerted on the payload. The at least one payload-receiving fixture can include a plurality of payload-receiving fixtures placed with respect to the payload to at least one of reduce payload deflection or prevent the payload from vibrating at a natural vibration frequency of the payload.

In some exemplary embodiments, the payload can include at least one elongate member that exhibits natural vibration frequencies within a range of frequency typically excited by a cargo aircraft during at least one of flight, landing, or ground operations. The payload can include one or more components of a wind turbine.

The at least one suspension element can comprise at least one actuator. In at least some such embodiments, the dynamic load reduction system can further include a controller, and the controller can be configured to both receive at least one predictive disturbance input and output one or more instructions to activate the at least one actuator in response to an expected dynamic load on the payload. The output in such embodiments can be based on the at least one predictive disturbance input. In some embodiments, the at least one actuator can include a linear actuator. The one or more instructions output by the controller can instruct the at least one actuator to at least one of displace the payload or exert a force on the payload. The controller can be further configured to actuate the at least one actuator in accordance with the at least one instruction. The controller can be further configured to transmit the at least one instruction to a user. The controller can be integrated into one or more payload-receiving fixtures of the at least one payload-receiving fixture.

In some exemplary embodiments, the system can further include a cargo aircraft. In such embodiments, the controller can be integrated into a control system of the cargo aircraft.

The at least one predictive disturbance input can be received from at least one sensor located on one or more of the payload, the at least one payload-receiving fixture, or the aircraft. The at least one predictive disturbance input can include one or more of a payload displacement, payload acceleration, payload-receiving fixture acceleration, airframe acceleration, aircraft instruction from a pilot, aircraft instruction from an electronic flight control system, atmospheric turbulence data, runway roughness, or wind gust data. In at least some such embodiments, the at least one predictive disturbance input can include at least one of the aircraft instruction from the pilot or the aircraft instruction from the electronic flight system. The aircraft instruction from the pilot or the aircraft instruction from the electronic flight system can pertain to an aircraft operation and/or environmental condition capable of causing an external disturbance to the payload.

The controller can include a feedforward controller, a feedback controller, or a combination of the two. In at least some embodiments, the controller can be configured to process the at least one predictive disturbance inputs through one or more gains to generate the at least one instruction. One or more of the one or more gains can be tuned for a particular operational phase of the aircraft. The particular operational phase can be one of in flight, landing, or ground operations. One or more of the one or more gains can be tuned for a particular payload or payload package. Additionally, or alternatively, one or more of the one or more gains can be adjusted during operation of the aircraft based on a dynamic response of the payload.

In some embodiments, the at least one suspension element of the dynamic load reduction system can include a spring-and-damper system. The spring-and-damper system can be coupled to one payload-receiving fixture of the at least one payload-receiving fixture, and further, it can be configured to couple to the payload received in it. The at least one the spring-and-damper system can be mounted in parallel with at least one actuator. The dynamic load reduction system can further include one or more tuned load reducers. The tuned load reducer(s) can be configured to be applied to a surface of the payload to further modify the at least one dynamic characteristic of the payload. In at least some such embodiments, the one or more tuned load reducers can include a tuned vibration absorber and/or a tuned mass damper. The at least one suspension element can be configured to be tuned manually and/or automatically.

In some exemplary embodiments, the dynamic load reduction system can be configured to be tuned to alter the at least one dynamic vibration characteristic of the payload based on a particular phase of aircraft operation. The particular phase of aircraft operation can be one of in-flight, landing, or ground operations. The dynamic load reduction system can be configured to be tuned to alter the at least one dynamic vibration characteristic of the payload based on a particular type and/or characteristic of a payload.

In at least one further embodiment, the system can further include a cargo aircraft having an interior cargo bay with a forward bay portion located in a forward end of the cargo aircraft and an aft bay portion located in an aft end of the cargo aircraft. The interior cargo bay of the cargo aircraft can further comprise a kinked bay portion disposed between the forward bay portion and the aft bay portion. The kinked bay portion can define a location at which the aft end of the cargo aircraft begins to raise relative to a longitudinal-lateral plane of the cargo. In some such embodiments, the at least one payload-receiving fixture can be configured to couple to the airframe within the interior cargo bay such that the payload extends from the forward bay portion, through the kinked bay portion, and into the aft bay portion of the interior cargo bay.

According to an additional aspect of the present disclosure, a method of managing a payload within an interior cargo bay of a cargo aircraft includes altering at least one dynamic vibration characteristic of a payload coupled to an airframe of the cargo aircraft by way of one or more payload-receiving fixtures within an interior cargo bay of the cargo aircraft. The altering the at least one dynamic characteristic of the payload occurs in response to a dynamic load being exerted by the airframe on the payload while the aircraft is at least one of in flight, landing, or performing ground operations.

In some embodiments, the at least one dynamic vibration characteristic can be one or more of a vibration frequency, a vibration mode shape, a vibration amplitude, or a vibration damping. The cargo aircraft can further include at least one actuator associated with at least one of the payload or at least one payload-receiving fixture of the one or more payload-receiving fixtures. The method can further include receiving, by a controller, at least one predictive disturbance input from one or more sensors, outputting, by the controller, one or more instructions to activate the at least one actuator based on the at least one predictive disturbance input, and actuating the at least one actuator in accordance with the one or more instructions to alter the at least one dynamic vibration characteristic of the payload.

In at least some embodiments, the at least one actuator can be mounted in parallel with at least one spring-and-damper system. The controller can actuate the at least one actuator in accordance with one or more instructions. The method can further include transmitting, by the controller, the one or more instructions to a user.

Actuating the at least one actuator in accordance with the one or more instructions can further include actuating the at least one actuator to displace the payload. Actuating the at least one actuator in accordance with the one or more instructions can further comprise actuating the at least one actuator to exert a force or moment on the payload. The at least one predictive disturbance input can include data received from at least one sensor located on one or more of the payload, the at least one payload-receiving fixture, or the aircraft. Additionally, or alternatively, the at least one predictive disturbance input can include one or more of a payload displacement, payload acceleration, payload-receiving fixture acceleration, airframe acceleration, aircraft instruction from a pilot, aircraft instruction from an electronic flight control system, atmospheric turbulence data, runway roughness, or wind gust data.

The controller can include closed-loop feedback logic and/or feedforward logic. In at least some embodiments, the method can further include processing, by the controller, the at least one predictive disturbance input using one or more gains to generate the at least one instruction. In at least some such embodiments, the method can further include tuning the one or more gains based on whether the aircraft is in flight, landing, or performing ground operations. Additionally, or alternatively, the method can further include tuning the one or more gains to particular characteristics of a particular payload. The method can further include tuning the one or more gains to particular characteristics of a particular payload. The method can further include tuning the one or more gains during operation of the aircraft based on a dynamic response of the payload.

In some embodiments, the cargo aircraft can have an interior cargo bay with a forward bay portion located in a forward end of the cargo aircraft and an aft bay portion located in an aft end of the cargo aircraft. The interior cargo bay of the cargo aircraft can further include a kinked bay portion disposed between the forward bay portion and the aft bay portion. The kinked bay portion can define a location at which the aft end of the cargo aircraft begins to raise relative to a longitudinal-lateral plane of the cargo aircraft. The one or more payload-receiving fixtures can be configured to couple to the airframe within the interior cargo bay. Accordingly, the payload can extend from the forward bay portion, through the kinked bay portion, and into the aft bay portion of the interior cargo bay.

The one or more payload-receiving fixtures can include a plurality of payload-receiving fixtures placed with respect to the payload to minimize the dynamic load exerted on the payload. The at least one payload-receiving fixture can include a plurality of payload-receiving fixtures placed with respect to the payload to reduce payload deflection and/or prevent the payload from vibrating at a nature vibration frequency of the payload. The payload can include at least one elongate member that can exhibit natural vibration frequencies within a range of frequency typically experienced by a cargo aircraft during at least one of flight, landing, or ground operations. The payload can include one or more components of a wind turbine.

### BRIEF DESCRIPTION OF DRAWINGS

This disclosure will be more fully understood from the following detailed description taken in conjunction with the accompanying drawings, in which:

FIG. 1A is an isometric view of one exemplary embodiment of an aircraft;

FIG. 1B is a side view of the aircraft of FIG. 1A;

FIG. 2A is an isometric view of the aircraft of FIG. 1A with a nose cone door in an open position to provide access to an interior cargo bay of the aircraft;

FIG. 2B is an isometric view of the aircraft of FIG. 2A with a payload being disposed proximate to the aircraft for loading into the interior cargo bay;

FIG. 2C is an isometric, transparent view of the aircraft of FIG. 1A having a payload disposed therein using a rail system;

FIG. 3 is a schematic side view of an aircraft in the prior art, illustrating a lateral axis of rotation with respect to tail strike;

FIG. 4 is a side view of an alternative exemplary embodiment of an aircraft;

FIG. 5 is a side view of the aircraft of FIG. 4 in a take-off position;

FIG. 6 is the side cross-sectional view of the aircraft of FIG. 6A with an exemplary payload disposed in the interior cargo bay;

FIG. 7 is a side partial cross-sectional view of another exemplary embodiment of an aircraft, a fuselage of the aircraft, and a payload supported by two payload-receiving fixtures within an interior cargo bay of the aircraft, each payload-receiving fixture including at least one payload-receiving fixture;

FIG. 8 is a perspective view of the payload-receiving fixture of FIG. 7, the payload-receiving fixture including a dynamic load reduction system;

FIG. 9 is a perspective view of the payload-receiving fixture of FIGS. 7 and 8 with the payload received therein;

FIG. 10A is a perspective view of part of a carriage of the payload-receiving fixture of FIG. 8, illustrating the part of the carriage with and without a brace disposed between two sets of wheels;

FIG. 10B is an isometric view of one exemplary embodiment of the part of the carriage of FIG. 10A being disposed in an interior cargo bay and in an unattached position;

FIG. 10C is an isometric view of the part of the carriage of FIG. 10B disposed in the interior cargo bay and in a mounted position;

FIG. 10D is an isometric view of one exemplary embodiment of a hardpoint fitting for securing the payload-receiving fixture of FIG. 8 to the interior cargo bay;

FIG. 11 is an enlarged perspective view of the payload-receiving fixture of FIG. 9, showing the dynamic load reduction system coupled to an underside of the payload;

FIG. 12 is a schematic diagram of the dynamic load reduction system of FIG. 7;

FIG. 13A is a front view of one exemplary embodiment of a passive damper that may be utilized with dynamic load reduction systems of the present disclosure;

FIG. 13B is a schematic front view of another exemplary embodiment of a passive damper that may be utilized with dynamic load reduction systems of the present disclosure;

FIG. 13C is a front view of yet another exemplary embodiment of a passive damper that may be utilized with dynamic load reduction systems of the present disclosure;

FIG. 13D is a top view of a piston plate of the passive damper of FIG. 13C;

FIG. 13E is a front view of another exemplary embodiment of a passive damper that may be utilized with dynamic load reduction systems of the present disclosure;

FIG. 14A is a perspective view of one exemplary embodiment of a tuned vibration absorber that may be utilized with dynamic load reduction systems of the present disclosures;

FIG. 14B is a further perspective view of the tuned vibration absorber of FIG. 14A;

FIG. 14C is a side view of the tuned vibration absorber of FIG. 14A;

FIG. 14D is a top view of the tuned vibration absorber of FIG. 14A;

FIG. 15A is a perspective view of one exemplary embodiment of a tuned vibration damper that may be utilized with dynamic load reduction systems of the present disclosures;

FIG. 15B is a perspective view of another exemplary embodiment of a tuned vibration damper that may be utilized with dynamic load reduction systems of the present disclosures;

FIG. 16 is a schematic diagram of one exemplary embodiment of an active dynamic load reduction system;

FIG. 17 is a schematic block diagram of the active dynamic load reduction system of FIG. 16 applied to the aircraft of FIG. 7;

FIG. 18A is a front view of one exemplary embodiment of an active damper that may be utilized with dynamic load reduction systems of the present disclosure;

FIG. 18B is a top view of a piston plate of the passive damper of FIG. 18A;

FIG. 18C is a front view of another exemplary embodiment of an active damper that may be utilized with dynamic load reduction systems of the present disclosure;

FIG. 19 is an enlarged perspective view of a payload-receiving fixture including a dynamic load reduction system having at least one passive load reduction element and at least one active load reduction element;

FIG. 20 is a schematic diagram of the dynamic load reduction system of FIG. 19 applied to the aircraft of FIG. 7; and

FIG. 21 is a schematic block diagram of one exemplary embodiment of a computer system for use in conjunction with the present disclosures.

### DESCRIPTION

Certain exemplary embodiments will now be described to provide an overall understanding of the principles of the structure, function, manufacture, and use of the devices, systems, aircraft, and methods disclosed herein. One or more examples of these embodiments are illustrated in the accompanying drawings. Those skilled in the art will understand that the devices, systems, aircraft, components related to or otherwise part of such devices, systems, and aircraft, and methods specifically described herein and illustrated in the accompanying drawings are non-limiting embodiments and that the scope of the present disclosure is defined solely by the claims. The features illustrated or described in connection with one embodiment may be combined with the features of other embodiments. Such modifications and variations are intended to be included within the scope of the present disclosure. Some of the embodiments provided for herein may be schematic drawings, including possibly some that are not labeled as such but will be understood by a person skilled in the art to be schematic in nature. They may not be to scale or may be somewhat crude renderings of the disclosed components. A person skilled in the art will understand how to implement these teachings and incorporate them into systems, methods, aircraft, and components related to each of the same.

To the extent the present disclosure includes various terms for components and/or processes of the disclosed devices, systems, aircraft, methods, and the like, one skilled in the art, in view of the claims, present disclosure, and knowledge of the skilled person, will understand such terms are merely examples of such components and/or processes, and other components, designs, processes, and/or actions are possible. By way of non-limiting example, while the present application describes loading an airplane through a front end of the aircraft, alternatively, or additionally, loading can occur through an aft end of the aircraft and/or from above and/or below the aircraft. In the present disclosure, like-numbered and like-lettered components of various embodiments generally have similar features when those components are of a similar nature and/or serve a similar purpose. To the extent terms such as front, back, top, bottom, forward, aft, proximal, distal, etc. are used to describe a location of various components of the various disclosures, such usage is by no means limiting, and is often used for convenience when describing various possible configurations. The foregoing notwithstanding, a person skilled in the art will recognize the common vernacular used with respect to aircraft, such as the terms “forward” and “aft,” and will give terms of those nature their commonly understood meaning. Further, in some instances, terms like forward and proximal or aft and distal may be used in a similar fashion.

The present disclosure is related to large, transport-category aircraft (e.g., fixed-wing, non-buoyant, and multi-engine jet aircraft), capable of moving oversized cargo not traditionally shippable by air. For example, wind turbine blades, which are typically highly elongated and irregular in shape to provide greater electrical power generating efficiency, or similarly long industrial equipment, shipping containers, or military equipment. The present disclosure is not limited to these specific cargos or payloads, but rather, these are examples. Examples of the present disclosure include extremely long cargo aircraft (e.g., longer than 60 meters, or even longer than 84 meters) with a kink in the fuselage about the lateral pitch axis, which allows for the transportation of long payloads or cargos while also meeting the tail strike requirement by allowing the cargo to extend longitudinally aft and upwards to locations that are vertically above the upper surface of the forwards fuselage.

Accelerations experienced during a cargo aircraft flight can be transferred to any payload disposed within cargo hold of the aircraft. Some payload items, such as wind turbine blades that may be transported by large cargo aircraft, may exhibit resonant frequencies within the frequency range of excitation applied to them during aircraft operation. Those accelerations, in turn, can produce loads on and displacements of the cargo. Two ways to reduce the resulting response provided by the present disclosures include: 1) manipulating dynamic characteristics of the cargo; and/or 2) reducing the acceleration on the blades by means of the use of active and/or passive devices. As used herein, a dynamic characteristic (also referred to as a dynamic vibration characteristic) can refer to one or more of the following: a vibration frequency, a vibration mode shape, a vibration amplitude, a vibration damping.

It is possible to manipulate the dynamic characteristics of the payload by means of a combination of devices applied to the suspension and/or directly to the payload. Considering the different excitation spectra experienced by an aircraft in its phases of operations, it can be desirable to have a tunable and/or adaptive system that can optimize the response in each of flight, landing, and/or ground operations.

The present disclosure provides for aircraft load management systems that can dynamically operate in a passive and/or active manner to manage the impact flight can have on a payload. The active systems described herein utilize various damping features provided for herein or otherwise known to those skilled in the art to adjust dynamic characteristics of a payload in real-time in response to feedback from an open or closed loop active control system. The passive systems described herein utilize configurations such as spring-and-damper suspensions, combined with devices such as vibration absorbers to passively adjust dynamic characteristics of a payload in real-time.

The described systems demonstrate particular usefulness when implemented in conjunction with large transportation vehicles, such as cargo aircrafts, at least because of the high loads experienced by large payloads in transport, such as when in flight. Accordingly, prior to describing the various embodiments and features of such load management systems, it is helpful to provide context by way of describing an exemplary large cargo aircraft in which the load management systems may be implemented.

### Aircraft

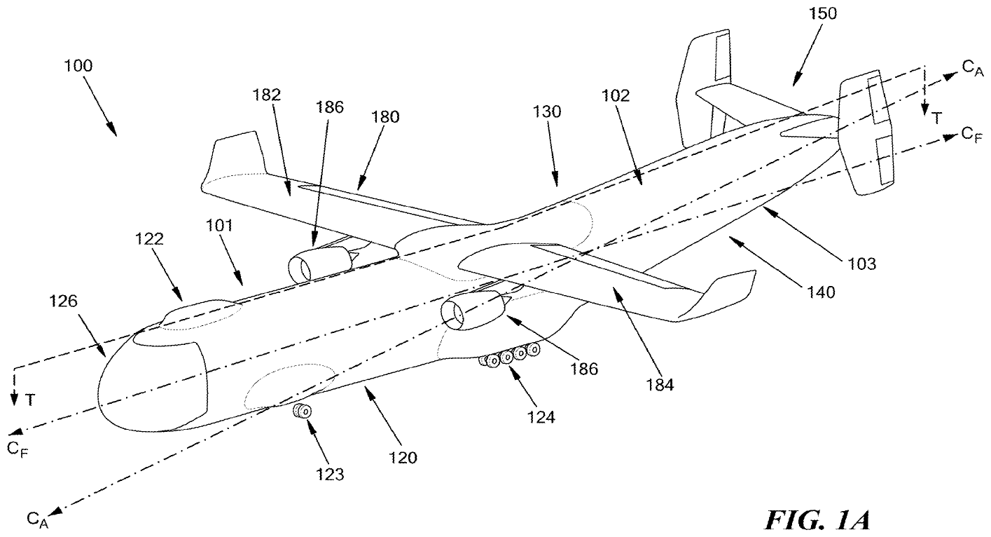

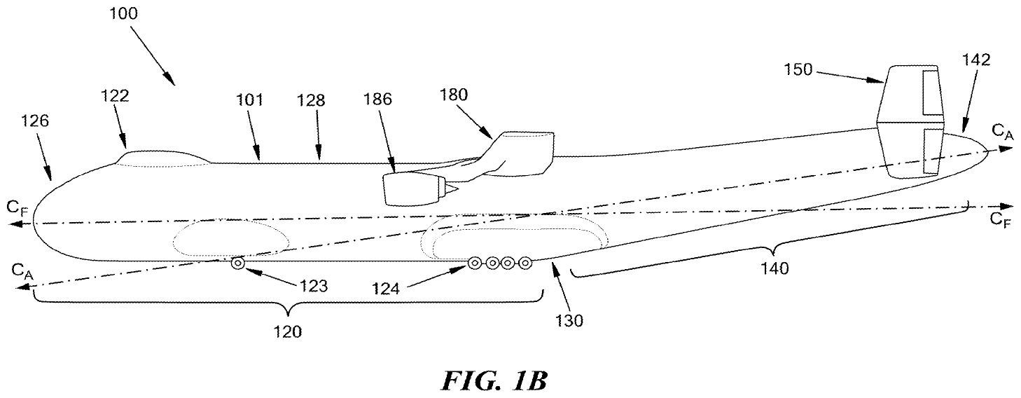

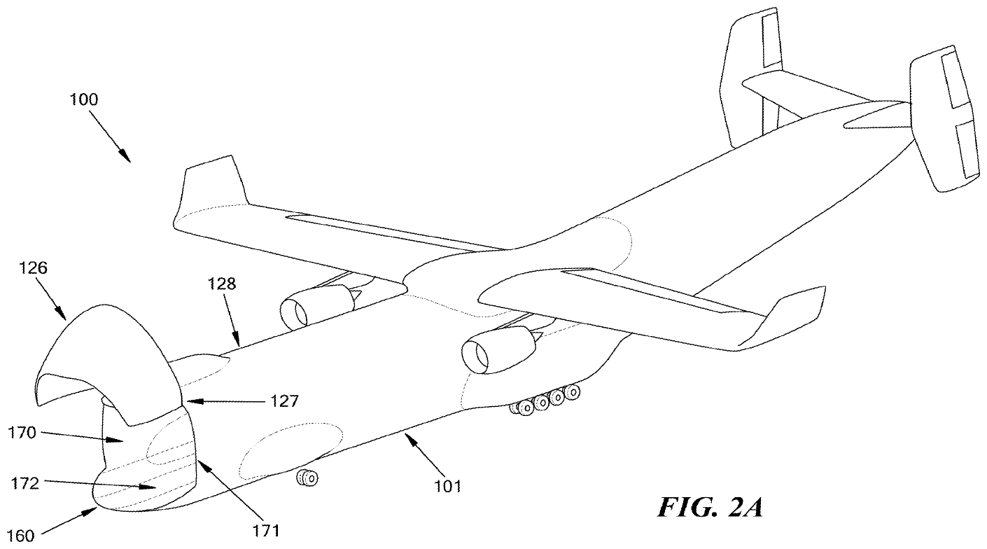

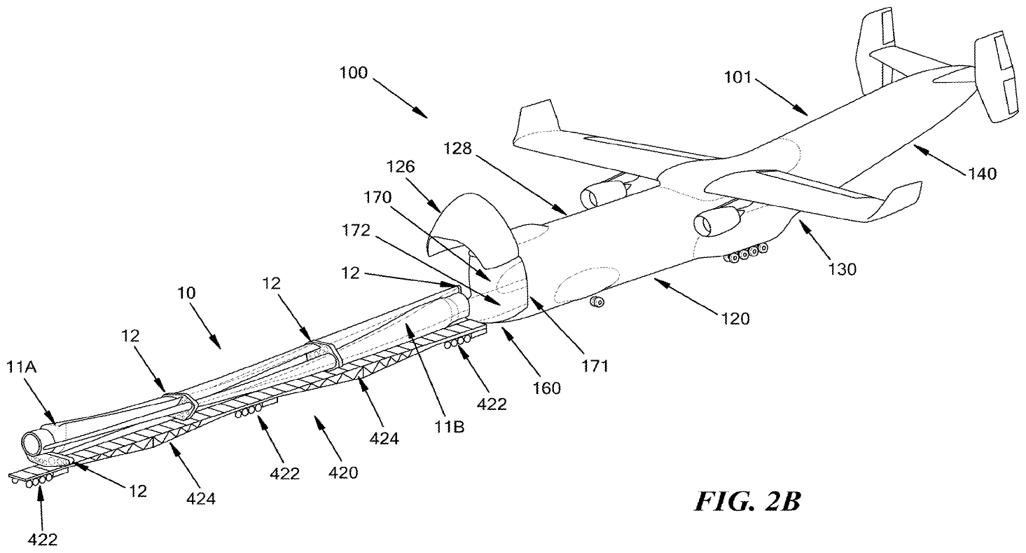

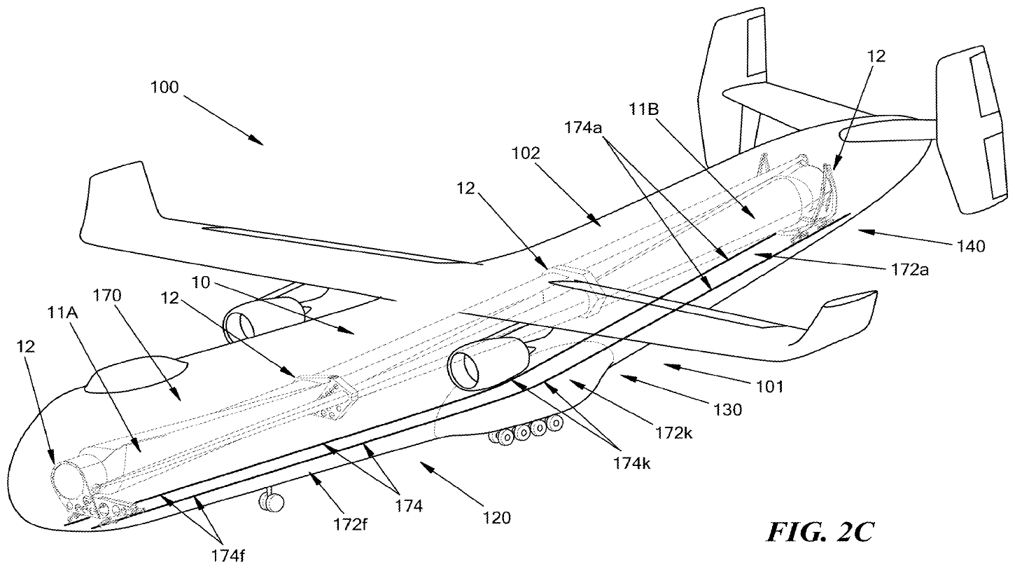

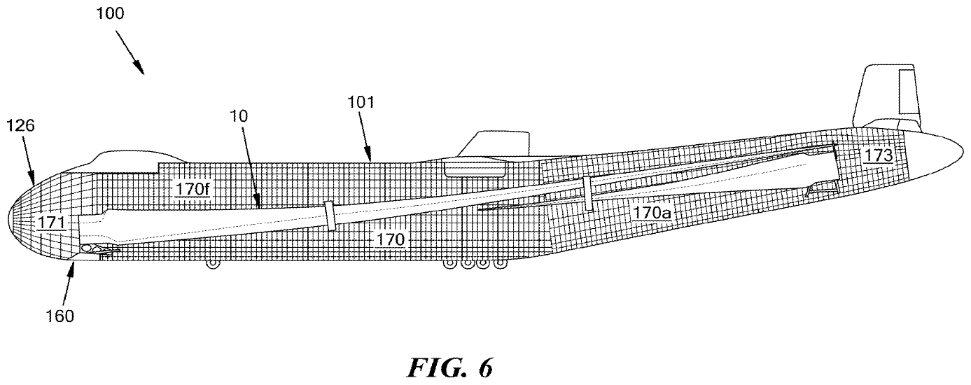

The focus of the present disclosures is described with respect to a large aircraft 100, such as an airplane, illustrated in FIGS. 1A and 1B, along with the loading of a large payload into the aircraft, illustrated at least in FIGS. 2A-2C and 6. In the illustrated embodiment, a payload 10 is a combination of two wind turbine blades 11A and 11B (FIGS. 2B and 2C), although a person skilled in the art will appreciate that other payloads are possible. Such payloads can include other numbers of wind turbine blades (e.g., one, two, three, four, etc., or segments of a single even larger blade), other components of wind turbines (e.g., tower segments, generator, hub, etc.), or other large structures and objects whether related to wind turbines or not. The present application can be used in conjunction with most any large payload—large for the present purposes being at least about 57 meters long, or at least about 60, 65, 75, 85, 90, 100, 110, or 120 meters long—or for smaller payloads if desired. Beyond wind turbines, the aircraft 100 can be used with most any size and shape payload, but has particular utility when it comes to large, often heavy and/or bulky and/or irregularly-shaped, payloads.

As shown, for example in FIGS. 1A, 1B, and 2A-2C, the aircraft 100, and thus its fuselage 101, includes a forward end 120 and an aft end 140, with a kinked portion 130 connecting the forward end 120 to the aft end 140. The forward end 120 is generally considered any portion of the aircraft 100, and related components, that are forward of the kinked portion 130 and the aft end 140 is considered any portion of the aircraft 100, and related components, that are aft of the kinked portion 130. The kinked portion 130 is a section of the aircraft 130 in which both a top-most outer surface 102 and a bottom-most outer surface 103 of the fuselage 101 become angled, as illustrated by an aft centerline CA of the aft end 140 of the fuselage 101 with respect to a forward centerline C F of the forward end 120 of the fuselage 101.

The forward end 120 can include a cockpit or flight deck 122, as shown located at a top portion of the aircraft, thus providing more space for cargo, and landing gears, as shown a forward or nose landing gear 123 and a rear or main landing gear 124. The forward-most end of the forward end 120 includes a nose cone 126. As illustrated more clearly in FIG. 2A, the nose cone 126 can be functional as a door, optionally referred to as the nose cone door, thus allowing access to an interior cargo bay 170 defined by the fuselage 101 via a cargo opening 171 exposed by moving the nose cone door 126 into an open or loading position as shown.

The interior cargo bay 170 is continuous throughout the length of the aircraft 101, i.e., it spans a majority of the length of the fuselage. The continuous length of the interior cargo bay 170 includes the space defined by the fuselage 101 in the forward end 120, the aft end 140, and the kinked portion 130 disposed therebetween. The interior cargo bay 170 can thus include the volume defined by nose cone 126 when closed, as well as the volume defined proximate to a fuselage tail cone 142 located at the aft end 140. The fixed portion 128 of the forwards fuselage 101 is the portion that is not the nose cone 126, and thus the forwards fuselage 101 is a combination of the fixed portion 128 and the nose cone 126. Alternatively, or additionally, the interior cargo bay 170 can be accessed through other means of access, including but not limited to a door located in the aft end 140.

One advantage provided by the illustrated configuration is that by not including an aft door, the interior cargo bay 170 can be continuous, making it significantly easier to stow cargo in the aft end 140 all the way into the fuselage tail cone 142. Existing large cargo aircraft are typically unable to add cargo in this way (e.g., upwards and aftwards) because any kink present in their aft fuselage is specifically to create more vertical space for an aft door to allow large cargo into the forwards portion of the aircraft.

A floor 172 can be located in the interior cargo bay 170, and can also extend in a continuous manner, much like the bay 170 itself, from the forward end 120, through the kinked portion 130, and into the aft end 140. The floor 172 can thus be configured to have a forward end 172f, a kinked portion 172k, and an aft end 172a. In some embodiments, the floor 172 can be configured in a manner akin to most floors of cargo bays known in the art. In some other embodiments, one or more rails can be disposed in the interior cargo bay 170 and can be used to assist in loading a payload, such as the payload 10, into the interior cargo bay 170 and/or used to help secure the location of a payload once it is desirably positioned within the interior cargo bay 170. In order for a cargo aircraft 100 to have as large of a cargo bay 170 as possible, the bottom contact surface 172 can be, effectively, the inner-facing side of the exterior skin of the fuselage. In such an arrangement, the bottom contact surface 172 is not designed to carry significant of the weight of the payload. Instead, rails can be structurally integrated with the fuselage 101 to carry the weight of the payload. A traditional cargo bay floor can be provided using a plurality of cargo bay floor segments that removably attach to the rails and can be advanced into the cargo bay 170 to form a continuous flat cargo bay floor.

Opening the nose cone 126 not only exposes the cargo opening 171 and the floor 172, but it also provides access from an outside environment to a cantilevered tongue 160 that extends from or otherwise defines a forward-most portion of the fixed portion 128 of the fuselage 101. The cantilevered tongue 160 can be used to support a payload, thus allowing the payload to extend into the volume of the interior cargo bay 170 defined by the nose cone 126.

A wingspan 180 can extend substantially laterally in both directions from the fuselage. The wingspan 180 includes both a first and second fixed wings 182, extending substantially perpendicular to the fuselage 101. In the illustrated embodiment, two engines 186, one mounted to each wing 182, 184, are provided, and other locations for engines are possible, such as being mounted to the fuselage 101.

The kinked portion 130 provides for an upward transition between the forward end 120 and the aft end 140. The kinked portion 130 includes a kink, i.e., a bend, in the fixed portion 128 of the fuselage 101 such that both the top-most outer surface 102 and the bottom-most outer surface 103 of the fuselage 101 become angled with respect to the centerline C F of the forward end 120 of the aircraft 100. Notably, although the present disclosure generally describes the portions associated with the aft end 140 as being “aft,” in some instances they may be referred to as part of a “kinked portion” or the like because the entirety of the aft end 140 is angled as a result of the kinked portion 130. Despite the angled nature of the aft end 140, the aircraft 100 is specifically designed in a manner that allows for the volume defined by the aft end 140, up to almost the very aft-most tip of the aft end 140, i.e., the fuselage tail cone 142, to receive cargo as part of the continuous interior cargo bay 170.

Proximate to the fuselage tail cone 142 can be an empennage 150, which can include horizontal stabilizers for providing longitudinal stability, elevators for controlling pitch, vertical stabilizers for providing lateral-directional stability, and rudders for controlling yaw, among other empennage components known to those skilled in the art.

The aircraft 100 is particularly well-suited for large payloads because of a variety of features, including its size. A length from the forward-most tip of the nose cone 126 to the aft-most tip of the fuselage tail cone 142 can be approximately in the range of about 60 meters to about 150 meters. Some non-limiting lengths of the aircraft 100 can include about 80 meters, about 84 meters, about 90 meters, about 95 meters, about 100 meters, about 105 meters, about 107 meters, about 110 meters, about 115 meters, or about 120 meters. Shorter and longer lengths are possible. A volume of the interior cargo bay 170, inclusive of the volume defined by the nose cone 126 and the volume defined in the fuselage tail cone 142, both of which can be used to stow cargo, can be approximately in the range of about 1200 cubic meters to about 12,000 cubic meters, the volume being dependent at least on the length of the aircraft 100 and an approximate diameter of the fuselage (which can change across the length). One non-limiting volume of the interior cargo bay 170 can be about 6850 cubic meters. Not accounting for the very terminal ends of the interior cargo bay 170 where diameters get smaller at the terminal ends of the fuselage 101, diameters across the length of the fuselage, as measured from an interior thereof (thus defining the volume of the cargo bay) can be approximately in the range of about 4.3 meters to about 13 meters, or approximately in the range of about 8 meters to about 11 meters. One non-limiting diameter of the fuselage 101 proximate to its midpoint can be about 9 meters. One non-limiting length of the wingspan 180 can be about 80 meters.

A person skilled in the art will recognize these sizes and dimensions are based on a variety of factors, and thus they are by no means limiting. Nevertheless, the large sizes that the present disclosure both provides the benefit of being able to transport large payloads, but faces challenges due, at least in part, to its size that make creating such a large aircraft challenging. The engineering involved is not merely making a plane larger. As a result, many innovations tied to the aircraft 100 provided for herein, and in other commonly-owned patent applications, are the result of very specific design solutions arrived at by way of engineering.

### Payload Loading, Unloading, and Stowing

FIGS. 2B and 2C provide for a general, simplified illustration of one exemplary embodiment of loading a large payload 10 into the aircraft 100. As shown, the cargo nose door 126 is open, exposing the interior cargo bay 170, which can extend through the kinked portion 130 and through essentially the entirety of the aft end 140. The cargo opening 171 provides access to the interior cargo bay 170, and the cantilevered tongue 160 can be used to help initially receive the payload. As shown, the payload 10 includes two wind turbine blades 11A, 11B, held with respect to each other by payload-receiving fixtures 12. The payload-receiving fixtures 12 are generally considered part of the payload, although in an alternative interpretation, the payload 10 can just be configured to be the blades 11A, 11B.

The payload 10, which can also be referred to as a package, particularly when multiple objects (e.g., more than one blade, a blade(s) and ballast(s)) are involved, possibly secured together and manipulated as a single unit, can be delivered to the aircraft 100 using most any suitable devices, systems, vehicles, or methods for transporting a large payload on the ground. A package can involve a single object though. In the illustrated embodiment, a transport vehicle 420 includes a plurality of wheeled mobile transporters 422 linked together by a plurality of spans, as shown trusses 424. Alternatively, or additionally, an outside mechanism can be used to move the vehicle 420, such as a large vehicle to push or pull the vehicle 20, or various mechanical systems that can be used to move large payloads, such as various combinations of winches, pulleys, cables, cranes, and/or power drive units.

As shown in FIG. 2B, the transport vehicle 420 can be driven or otherwise moved to the forward end 120 of the aircraft 100, proximate to the cargo opening 171. Subsequently, the payload 10 can begin to be moved from the transport vehicle 420 and into the interior cargo bay 170. This can likewise be done using various combinations of one or more winches, pulleys, cables, cranes, and/or power drive units, such set-ups and configurations being known to those skilled in the art. The system and/or methods used to move the payload 10 into the cargo bay 170 can continue to be employed to move the payload 10 into the fully loaded position illustrated in FIG. 2C. FIG. 2C is a perspective view of the cargo aircraft 100 of FIG. 1A showing a pair of rails 174 coupled to, extending from, or otherwise associated with the bottom contact surface 172 of the cargo bay 170 that extends along the cargo bay 170 from a forward entrance to and through the aft section of the cargo bay 170 in the aft portion 140 (not visible) of the fuselage 101. The rails 174 can thus be configured to have a forward end 174f, a kinked portion 174k, and an aft end 174a. In some embodiments, the rail(s) 174 can serve as a primary structural member(s) or beam(s) of the fuselage 101, capable of bearing operational flight and/or ground loads, akin to a keel beam in some aircraft.

Additional details about tooling for cargo management, including rails and payload-receiving fixtures and fuselage configuration for enabling loading and unloading of payloads into aft regions of a continuous interior cargo bay are provided in International Patent Application No. PCT/US2020/049784, entitled “SYSTEMS AND METHODS FOR LOADING AND UNLOADING A CARGO AIRCRAFT,” and filed Sep. 8, 2020, and the content of which is incorporated by reference herein in its entirety.

As a result of the unique nature of the kinked cargo bay configuration, new challenges arise when trying to load or unload large cargo into or out of the non-linear cargo bay. One solution involves systems and methods for loading and unloading the cargo along a curved path inside the fuselage. Examples include tooling and fixtures to enable moving a large cargo in a forward or aft direction while concurrently rotating the large cargo about a center point of an arc such that the large cargo moves along a curved or arc path in a forward or aft direction within the aircraft. Additional details are provided in International Patent Application No. PCT/US2021/21794, entitled “SYSTEMS AND METHODS FOR LOADING AND UNLOADING A CARGO AIRCRAFT UTILIZING A CURVED PATH,” and filed Mar. 10, 2021, and the content of which is incorporated by reference herein in its entirety.

### Kinked Fuselage

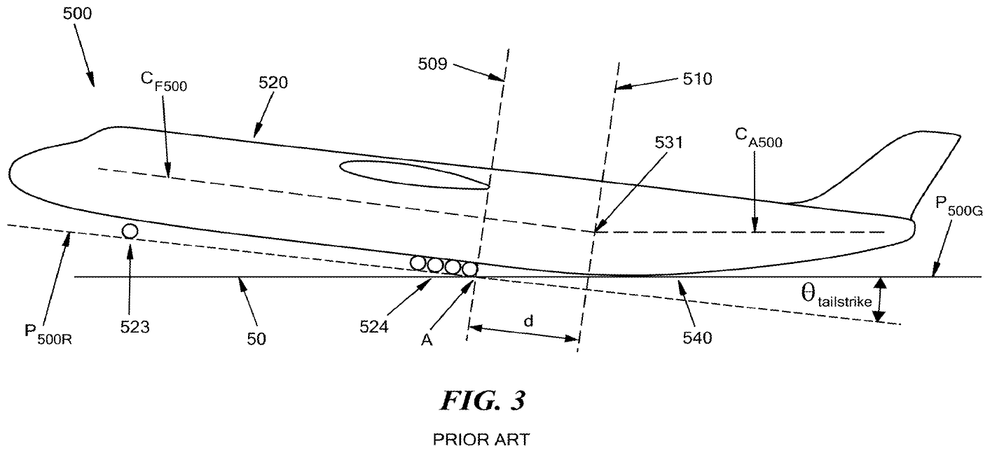

FIG. 3 is an illustration of a prior art aircraft 500 during a takeoff pitch-up maneuver showing the calculating of a tailstrike angle (θₜₐᵢₗₛₜᵣᵢₖₑ), which is determined when a forward end 520 of the aircraft 500 is lifted away from the ground P_{500G} (e.g., a runway of an airport) and an aft end 540 and tail of the aircraft 500 is pushed towards the ground 50 until contact. This change occurs during a takeoff pitch-up maneuver when the aircraft 500 pitches (e.g., rotates) about a lateral axis of rotation, indicated as “A” in FIG. 3. This lateral axis of rotation, A, is typically defined by the main landing gear 524, which acts as a pivot point to allow a downwards force generated by the tail to lift the forward end 520 of the aircraft 500. In FIG. 3, the nose landing gear 523 and main landing gear 524 define a resting plane P_{500R} (e.g., plane horizontal with the ground plane P_{500G} when the aircraft is resting), such that the tailstrike angle θₜₐₗₗₛₜᵣᵢₖₑ can be defined by the change in the angle of the ground plane P_{300G} with respect to the resting plane P_{500R} when the aircraft 500 has achieved a maximal pitch angle or takeoff angle, which occurs just before any part of the aft end 540 of the aircraft 500 strikes the ground. In FIG. 3, a forward center line C_{F500} of the aircraft 500 is shown, along with an aft centerline C_{A500}. In order to increase θₜₐᵢₗₛₜᵣᵢₖₑ, larger aircraft 500 usually have an upsweep to the lower surface of an aft region of the aft fuselage. This upsweep deflects the centerline C_{A500} with respect to the forward center line C_{F500} at the initiation of the upsweep, which is shown in FIG. 3 as a bend 531 in the centerlines C_{F500}, C_{A500}. In prior art aircraft 500, this bend 531 occurs a certain distance, shown in FIG. 3 as distance “d” aft of the lateral axis of rotation A. Longer values of distance “d” increase the constant cross-section length of the aircraft 500. Aspects of the present disclosure eschew this prior art incentive for increasing distance “d” and instead significantly reconfigure the relationship between the aft fuselage and forward fuselage such that decreasing distance “d” can result in increasing the maximum usable cargo bay length.

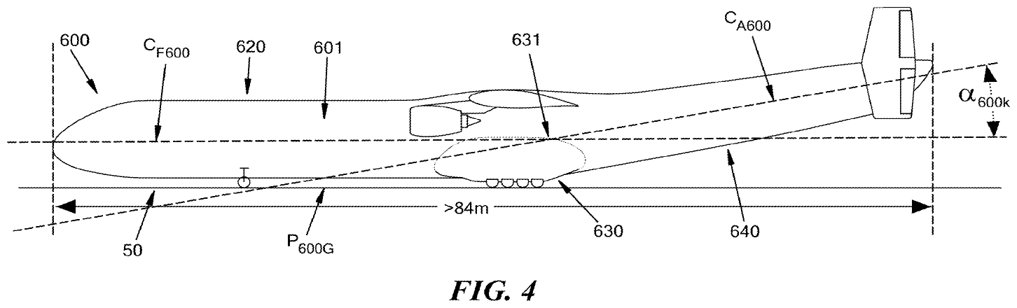

FIG. 4 is a side view illustration of an exemplary cargo aircraft 600 of the present disclosure. The aircraft 600, which is shown to be over 84 meters long, includes a fuselage 601 having a forward end 620 defining a forward centerline C_{F600} and an aft end 640 defining an aft centerline C_{A600}, with the aft centerline C_{A600} being angled up with respect to the forward centerline C_{F600}. The forward and aft centerlines C_{F600}, C_{A600} define a junction or kink 631 therebetween, where the forward centerline C_{F600} angles upward as the overall aft fuselage, which is in the aft end 640, changes in direction to be angled with respect to the forward fuselage, which is in the forward end 620. This defines a kink angle α₆₀₀ₖ of the aft fuselage 640. The kink location 631 is contained in the kinked portion 430 disposed between and connecting the forward and aft ends 620, 640.

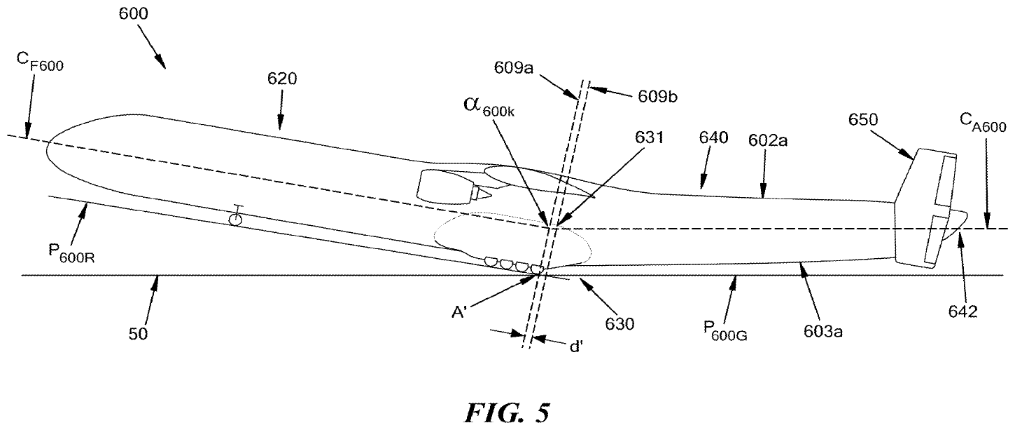

In FIG. 5, the angle of the aft centerline C_{A600} with respect to the forward centerline C_{F600} defines a kink or bend angle (illustrated as a_{600K} in FIG. 4), which can be approximately equal to an average of an angle of the after upper surface 602a and an angle of the lower surface 603a with respect to the forward centerline C_{F600}. Further, the kink angle α_{600K} can be approximately equal to a degree of maximal rotation of the aircraft during the takeoff operation. In FIG. 5, the cargo aircraft 600 is shown on the ground 50 and rotated about the lateral axis of rotation to illustrate, for example, a takeoff pitch-up maneuver. In FIG. 5, a resting plane P_{600R} of the forward end 620 angled with respect to the ground or ground plane P_{600G} at a degree just before ° twist-Ike, as no part of the aft end 640, empennage 650, or tail 642 is contacting the ground. In this position, the lower surface 603a (and, approximately, the aft centerline C_{A600}) is substantially parallel with the ground or ground plane P_{600G}, and it can be seen that because the location of the centerline kink 631 of the kinked portion 630 is approximately with, or very close to, the lateral axis of rotation A′, the angle α_{600K} of the kink 631 is approximately the maximum safe angle of rotation of the aircraft 600 about the lateral axis of rotation A′.

FIG. 5 shows a vertical axis 609a aligned with the location of the lateral axis of rotation A′ and another vertical axis 609b aligned with the kink 631 in the fuselage centerline C_{F600}, with a distance d′ therebetween. With d′ being small, and the lower surface 603a of the aft end 640 extending aft with approximately the kink angle α_{600K} of the kink 631 or a slightly larger angle, as shown, the aft end 640 is highly elongated without risking a tail strike. Moreover, the upward sweep of the upper surface 602a can be arranged to maintain a relatively large cross-sectional area along most of the aft end 640, thereby enabling a substantial increase in the overall length of the cargo aircraft 600, and thus usable interior cargo bay within the aft end 640, without increasing θₜₐᵢₗₛₜᵣᵢₖₑ. Vertically aligning the kink location 131 with the lateral pitch axis can enable the aft fuselage 140 to extend without decreasing θₜₐᵢₗₛₜᵣᵢₖₑ, which also can enable the useable portion of the interior cargo bay 170 to extend aft along a substantial portion of the aft fuselage 140. The present designs also enable the creation of extremely long aircraft designs capable of executing takeoff and landing operations with shorter runway lengths than previously possible.

Examples of the aircraft 100 also include complex fuselage changes (e.g., the forward-to-aft kink or bend angle in the fuselage and interior cargo bay centerline) occurring over multiple transverse frames and longitudinally continuous skin panels, thus reducing the overall structural complexity of the transition zone. Additional details about kinked fuselages are provided in International Patent Application No. PCT/US21/21792, entitled “AIRCRAFT FUSELAGE CONFIGURATIONS FOR UPWARD DEFLECTION OF AFT FUSELAGE,” and filed Mar. 10, 2021, and the content of which is incorporated by reference herein in its entirety.

### Cargo Bay

FIG. 6 is side cross-section view of the cargo aircraft 100, the cross-section being taken along an approximate midline T-T of the top-most outer surface, as shown in FIG. 1A. The cargo bay 170 extends from a forward end 171 of a forward end or region 170f of the cargo bay 170, as shown located in the nose cone 126, to an aft end 173 of an aft end or region 170a of the cargo bay 170, as shown located in the fuselage tail cone 142. The forward and aft regions 170f, 170a of the cargo bay 170 sit within the forward and aft ends 120, 140, respectively, of the aircraft 100. FIG. 6 shows the aft region 170a of the cargo bay 170 extending through almost all of the aft fuselage 140, which is a distinct advantage of the configurations discussed herein. FIG. 6 shows a highly elongated payload 10 of two wind turbine blades 11A, 11B disposed substantially throughout the interior cargo bay 170 and extending from the forward end 171 of the forward region 170f to the aft end 173 of the aft region 170a.

Additional details about a kinked fuselage configuration are provided in commonly-owned International Patent Application No. PCT/US20/49787, filed on Sep. 8, 2020, entitled “AIRCRAFT FUSELAGE CONFIGURATIONS FOR AVOIDING TAIL STRIKE WHILE ALLOWING LONG PAYLOADS,” the content of which is incorporated by reference herein in its entirety.

### Load Management Systems

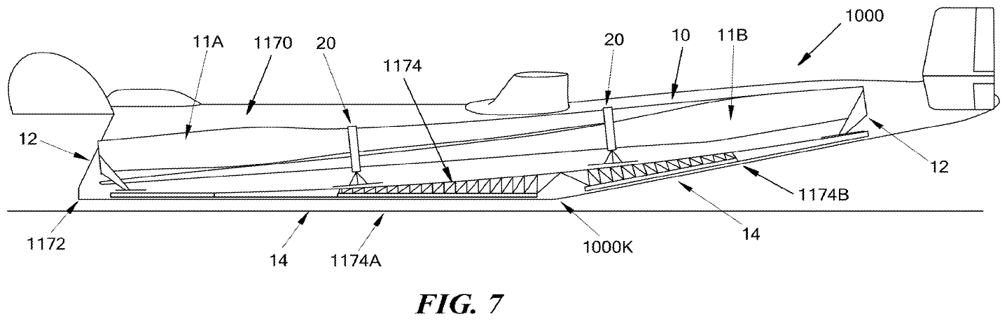

FIG. 7 illustrates another exemplary embodiment of a cargo aircraft, as shown aircraft 10. The aircraft 1000 is similar to the aircraft 100 described with respect to FIGS. 1-6, although the aircraft 1000 provides a different configuration of its rails (the rails being rails 1174 for the aircraft 1000). The rails of the aircraft 1000 include a forward support structure 1174A and an aft support structure 1174B that can be secured, either permanently or removably, to a bottom contact surface 1172 of the aircraft. Additional details about how these support structures 1174A, 1174B can form a curved or arc path to assist in loading and/or unloading a payload from the aircraft 1000 are provided in International Patent Application No. PCT/US2021/21794, the contents of which is incorporated by reference above.

FIG. 7 also illustrates an aircraft load management system 14. The system 14 can be incorporated along with one or more payload-receiving fixtures, such as the payload-receiving fixtures 20 described herein, or the payload-receiving fixtures 12 of FIGS. 2B and 2C, which can be used to support at least one elongated piece of cargo 10, as shown the blades 11A and 11B. One or more of the payload-receiving fixtures 20 can include a dynamic load reduction system 38. As used herein, the term dynamic load reduction system may sometimes refer to a singular system associated with a singular fixture, while it can also refer to a plurality of systems and/or a plurality of fixtures having at least one such system incorporated therein. The dynamic load reduction system 38 of each payload-receiving fixture 20, which may be either passive or active, can reduce loads acting on the elongated cargo (i.e., the two wind turbine blades 11A, 11B) in the aircraft 1000. A person skilled in the art will appreciate that the systems, methods, and principles presented herein can be equally applicable to payloads beyond wind turbine blades. More broadly, the present disclosure can be applied to any payload or cargo having a dynamic response during at least one of aircraft flight, landing, and/or ground operations that lead to high internal and reaction loads on the payload. As such, any reference to functionality and operability of components of the present disclosure in the context of turbine blades is applicable to any other cargo contained within the aircraft 1000.

Wind turbine blades have inherent dynamic characteristics, represented by their normal modes of vibration, and thus exhibit vibration frequencies within the range of frequency typically experienced by a cargo aircraft in flight, landing, and ground operations. The dynamic response of the blade can lead to high internal and reaction loads. The load management system 14 can protect the structural integrity of the blades 11A, 11B during flight, landing, and ground operations, including taxing, pre-flight inspections, post-flight inspections, and the like. The system 14 overall, including at least the payload-receiving fixtures 20 and the two end fixtures 12, provides for at least one of: (i) minimization of dynamic loads exerted on the blades 11A, 11B; (ii) prevention or reduction of undesirable deflection of the blades 11A, 11B; and/or (iii) prevention of undesirable natural vibration frequency of the blades 11A, 11B. In the illustrated embodiment, a payload-receiving fixture 20 is arranged, placed, and/or secured, for example during transport, on the forward support structure 1174A and another payload-receiving fixture 20 is arranged, placed, and/or secured, for example during transport, on the aft support structure 1174B. In other embodiments, the payload-receiving fixtures 20 can be directly arranged on the bottom contact surface 1172 or another suitable surface(s) (e.g., rails, like the rails 174) of the aircraft 1000.

As described in further detail below, the dynamic load reduction systems of the present disclosure may be an active load management system 200, in which the system can actively and predictively mitigate vibrations via actuators and/or controllers, or a passive load management system 14, in which reactionary dampers dampen vibrations as they occur. The systems can also be a combination of active and passive systems, as shown with the load management system 300.

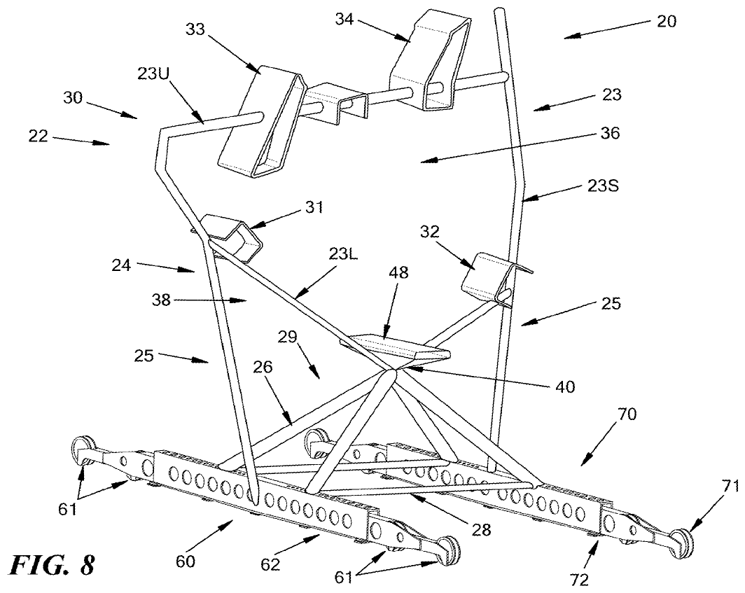

FIG. 8 illustrates one non-limiting embodiment of a payload-receiving fixture 20 having a dynamic load reduction system. The payload-receiving fixture 20 illustrated in FIG. 8 may be configured to receive, support, and restrain a mid-section of one or more turbine blades 11A, 11B or other cargo. Accordingly, the payload-receiving fixture 20 may be referred to as a mid-span payload-receiving fixture 20. Mid-span fixtures can also be used in conjunction with end fixtures, like the end fixtures 12 of FIGS. 2B and 2C, which can be arranged at a root and a tip of the blades 11A, 11B. A person skilled in the art, in view of the present disclosures, will understand how to incorporate dynamic load reduction systems into end fixtures to further support the blades and mitigate vibrations.

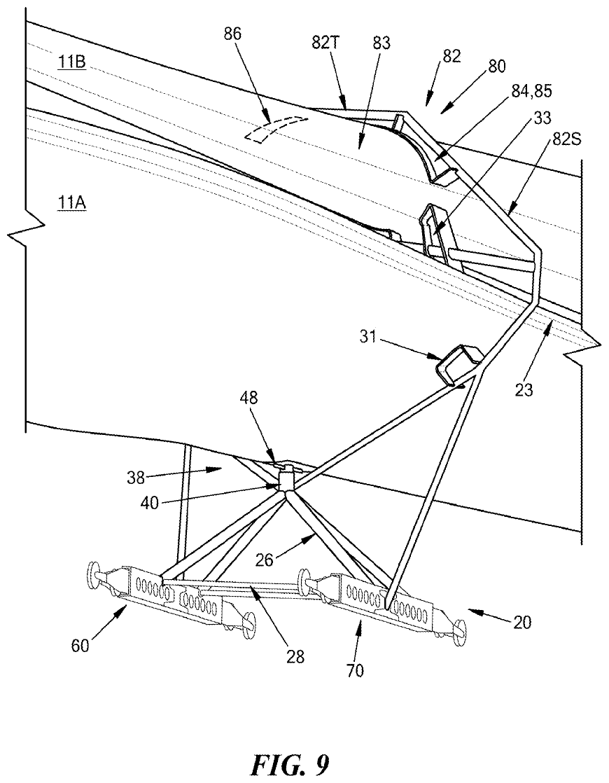

The payload-receiving fixture 20 may have at least one payload-receiving frame 22 configured to receive and support the blades 11A, 11B. In the illustrated embodiment, the at least one payload-receiving frame 22 includes a middle support frame, or mid-component, 23, a lower support frame, or lower component, 24, and an upper support frame, or upper component, 80 (see FIG. 9) that each may be removably secured to one another. For example, FIG. 9 demonstrates that the upper support frame 80 can be secured to the middle support frame 23 after the blade 11B is situated to be received therebetween. The various frames 23, 24, and 80 can be secured to each other using a variety of mechanical connections known to those skilled in the art, including but not limited to welding, fastening sleeves, bonded joints, and the like.

Each of the lower, middle, and upper support frames 24, 23, and 80 can include one or more rods 23L, 23S, 23U, 25, 26, 28, 82 connected together to form the frame, as shown in FIGS. 8 and 9. The support rods 23L, 23S, 23U, 25, 26, 28, 82 can be configured in a variety of manners, depending, at least in part, on cargo with which they will be used, the transport (e.g., aircraft) with which they will be used, etc., but as shown the support rods can substantially outline an outer surface of the cargo (e.g., the lower wind turbine blade 11A). By way of non-limiting example, in the illustrated embodiment, the lower support frame 24 can include a plurality of support rods 25 configured to support the middle support frame 23. As shown, the lower support frame 24 can include side support rods 25 that extend downwardly away from side portions of the middle support frame 23 and provide a base for the middle support frame 23 to rest on. In some embodiments, at least one side support rod 25 includes two additional supports at the lower end of the side support rod 25 to provide additional forward and rearward support to the side support rod 25. In the illustrated embodiment, the side support rods 25 are coupled to first and second carriages 60, 70, the carriages being described in further detail below. In other embodiments, such as an instance in which the payload-receiving fixture 20 is incorporated as part of the aircraft 1000, the side support rods 25 can be directly coupled to and supported by an inner surface 1170f of the fuselage 1001 of the aircraft 1000. In additional embodiments, the payload-receiving fixture 20 may only include the middle and upper support frames 23, 80, either as its own standalone payload-receiving fixture or being both directly coupled to and supported by the inner surface 1170f of the fuselage 1001 of the aircraft 1000.

In the illustrated embodiment, the lower support frame 24 further includes four angled support rods 26, two of which extend upwardly from two separate locations on the first carriage 60 and two of which extend upwardly from two separate locations on the second carriage 70, as shown in FIG. 8. The lower support frame 24 further can further include one or more base support rods 28, as shown two rods 28, which can extend between opposing coupling locations of the angled support rods 26. In some embodiments, a base support rod 28 and two angled support rods 26 can form a triangular support 29, where two of such triangular supports 29 can be coupled to a lower portion of the middle support frame 23. In this way, the two triangular supports 29 comprised of base support rods 28 and angled support rods 26 can provide additional support to the dynamic load reduction system 38 and/or a surface pad or receiver 48 that can be arranged on the lower portion of the middle support frame 23 as shown.

The upper support frame 80 can include an upper support rod assembly 82 that can extend around the upper portion of the upper turbine blade 11B, as shown in FIG. 9. Similar to the middle support frame 23, the upper support rod assembly 82 can closely surround the upper, outer surface of the upper wind turbine blade 11B about a generally singular longitudinal position of the blade 11B. By way of a non-limiting example, the illustrated embodiment of the upper support rod assembly 82 can include two or more side support rods 82S and at least one top support rod 82T (the second side support rod 82S can be on the opposing side of the blade 11B, although not visible in FIG. 9). The terminal ends of the two side support rods 82S can be coupled to upper connection points of the middle support frame 23. In other embodiments, such as an instance in which the payload-receiving fixture 20 is incorporated as part of the aircraft 1000, the upper support rod assembly 82 can be directly coupled to and supported by an inner surface 1170f of the fuselage 1001 of the aircraft 1000. A person skilled in the art will appreciate that the support frames 23, 24, 80 described herein may be modified in terms of the number of support frames utilized, the number of payload-receiving fixtures utilized, and/or the shapes of the support frames based, at least in part, on the structural requirements of the cargo 10 being carried in the aircraft 1000 as well as the requirements of the aircraft 1000 itself.

The middle support frame 23 defines a lower payload-receiving opening 36 therein that is configured to receive a portion of one of the two turbine blades 11A, 11B, in particular the lower turbine blade 11A. An upper payload-receiving opening 83 (see FIG. 9) can be formed between the middle support frame 23 and the upper support frame 80, the second payload-receiving recess 83 in the illustrated embodiment being configured to receive a portion of the other one of the two turbine blades 11A, 11B, in particular the upper turbine blade 11B.

As shown in FIG. 8, the payload-receiving fixture 20 further can include a lower payload attachment assembly 30. The attachment assembly 30 can include a plurality of lower payload attachment platforms or receivers 31, 32, 33, 34, 35 that can extend into the lower payload-receiving opening 36. Similarly, as shown in FIG. 9, the payload-receiving fixture 20 can further include an upper payload attachment assembly 84, which can include a plurality of upper payload attachment platforms or receivers 85, 86 (platform 86 shown in phantom in FIG. 9) that can extend into the upper payload-receiving opening 83.

The lower payload attachment receivers 31, 32, 33, 34, 35 and the upper payload attachment receivers 85 each include supporting surfaces that are formed to substantially match the contour of the portion of the turbine blade 11A, 11B that the receiver is configured to support. For example, as can be seen in FIG. 9, the lower payload attachment platform 31 can be sized and shaped to match the underside of the lower turbine blade 11A, the lower payload attachment platform 33 can be sized and shaped to match the lower, side portion of the upper turbine blade 11B, and the upper payload attachment platform 85 can be sized and shaped to match the upper side of the upper turbine blade 11B. A skilled person in the art would appreciate that the payload attachment receivers are by no means limiting, and that other number of receivers, and other shaped and sized receivers can be used.

More particularly, the lower payload attachment assembly 30 can include two lower payload attachment receivers 31, 32 arranged on generally lower portions of the middle support frame 23, in particular on the two lower support rods 23L, such that the two lower payload attachment receivers 31, 32 face generally upwardly and can support an underside of the lower turbine blade 11A. One side support rod 23S of the middle support frame 23 can include a side payload attachment receiver 35 that can face generally sideways and can support a side portion of the lower turbine blade 11A. The upper support rod 23U of the middle support frame 23 can include two upper payload attachment receivers 33, 34. The two upper payload attachment receivers 33, 34 can each extend some distance away from the upper support rod 23. Each receiver 33, 34 can include a lower surface that can support the upper surface of the lower turbine blade 11A and an upper surface that can support the lower surface of the upper turbine blade 11B. The upper payload attachment assembly 84 can include two upper payload attachment receivers 85, 86 that can face generally downwardly and can support the upper surface of the upper turbine blade 11B. A person skilled in the art will appreciate that the payload attachment receivers 31, 32, 33, 34, 35, 84, 85 described herein may be modified in terms of the number of receivers utilized, the position of the receivers on the frames, and the shapes of the receivers based, at least in part, on the structural requirements of the cargo 10 being carried in the aircraft 1000 as well as the requirements of the aircraft 1000 itself.

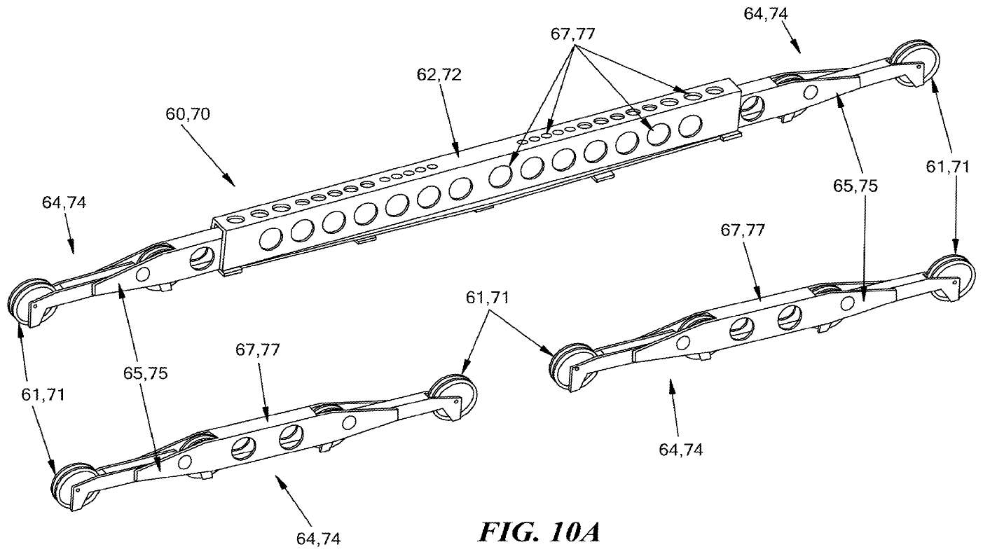

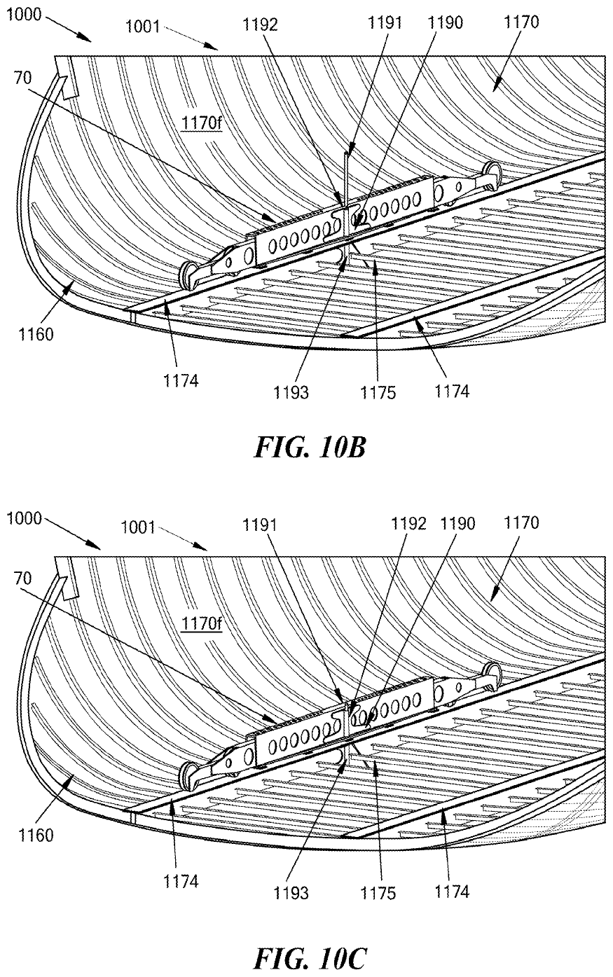

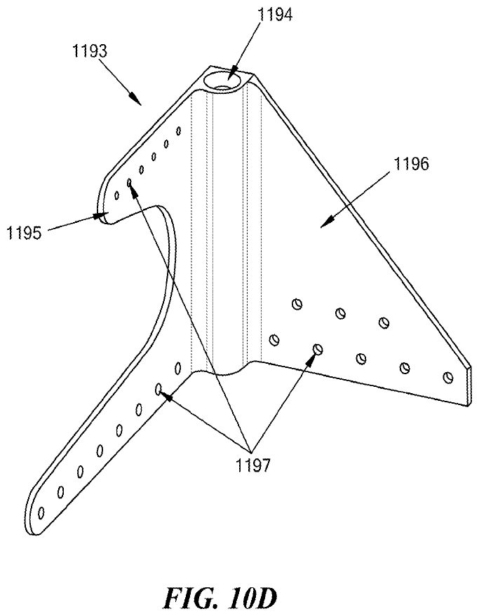

FIG. 10A illustrates one of the carriages 60, 70. The carriage 60, 70 can include a plurality of wheel sets 64, 74, with wheels 61, 71 of the wheel sets 64, 74 being coupled together by a whiffle tree 65, 75 in a linear configuration. The wheel sets 64, 74 and whiffle trees 65, 75 can aid in both moving the payload-receiving fixture 20, and thus a payload 10 received by the fixture 20, and can also help spread the weight of the payload 10 more evenly to the rails 1174, in particular the rails 1174 arranged on the support structures 1174A, 1174B. As shown, two whiffle trees 65, 75, and thus two-wheel sets 64, 74, can be coupled together by a rectangular brace 62, 72. The rectangular brace 62, 72 can itself act as a whiffle tree, and thus provide similar benefits as a whiffle tree.

A plurality of holes or openings 67, 77 are provided in the various surfaces of the brace 62, 72 as illustrated, as are a plurality of holes or openings 66, 76 in the whiffle trees 65, 75. The holes 66, 67, 76, 77 may improve aspects of the fixture 20 including, but not limited to, reducing the weight of the fixture 20 and/or providing possible locations where the fixture 20 can be secured within a cargo bay of an aircraft, such as by tying a rope or chain or the like through one or more of the openings and tightening accordingly to secure the location of the fixture 20, and thus the cargo 10 secured by the fixture 20, within the cargo bay.

FIGS. 10B and 10C illustrate one exemplary way by which the carriage 60, 70, in particular the second carriage 70 as shown in FIGS. 10B and 10C, can be secured inside a cargo bay of an aircraft. The functionality of the second carriage 70 as described herein, including all associated components, is applicable to the carriage 60. As shown, the second carriage 70 is disposed along the rail 1174 of the cargo bay 1170 of the aircraft 1000. The second carriage 70 can translate along the rail 1174 as described herein. When it reaches a desired location, as shown here, in the forward end 1170f of the cargo bay 1170 with a portion of the carriage 70 disposed on the cantilevered tongue 160, it can be secured by way of a mounting plate 1190 coupled to the carriage 70 and a locking pin 1191. More particularly, as shown, the mounting plate 1190 can be disposed on one of two opposed main surfaces of the rectangular brace 72.

The mounting plate 1190 includes a bore 1192 extending longitudinally therethrough. The bore 1192 can be aligned with a bore 1194 (FIG. 10D) of a hardpoint fitting 1193 coupled to the rail 1174 or otherwise disposed in the cargo bay. The locking pin 1191 can be driven into both bores 1192, 1194 to secure the location of the carriage 70 with respect to the rail 1174. When further transportation of the carriage 70 is desired, such as when unloading the cargo 90 from the aircraft 1000, the locking pin 1191 can be removed from the hardpoint fitting 1193 and/or the carriage 70, thereby permitting movement of the carriage 70 with respect to the rail 1174. Notably, although the carriage 70 is described in this context one of two carriages 60, 70, in other embodiments it can be a standalone carriage that is configured, perhaps in conjunction with other carriages disposed linearly along a length of a payload to be transported, to translate a payload through at least a portion of a cargo bay of the aircraft 1000.

A non-limiting exemplary embodiment of the hardpoint fitting 1193 is illustrated in FIG. 10D. The bore 1194 for receiving the locking pin 1191 extends throughout a length of hardpoint fitting 1193. Plates 1195, 1196 extend substantially perpendicular to each other from the portion of the fitting 1193 that forms the bore 1194, allowing the hardpoint fitting 1193 to be mounted to substantially perpendicular structures within the interior cargo bay 1170—as shown in FIGS. 10B and 10C, the rail 1174 and a cross beam 175. The plates 1195, 1196 can have a variety of configurations, and can be adapted for the surface(s) to which they will be connected. For example, the plate 1195, which includes a more curved profile, is configured to attach to the face of the rail 1174, with two lines of bolts (via bores 1194) being used to react to a load and a moment about the vehicle pitch axis, while the plate 1196, which has a more triangular shaped profile, is configured to attach to a fuselage transverse plane, which may be less tall than the rail 1174. Various bores 197 (not all labeled) can be formed therein to assist in mounting the hardpoint fitting 1193 within the cargo bay 1170. Any number of hardpoint fittings 1193 (or other configurations of hardpoint fittings) can be provided throughout the entirety of the interior cargo bay 1170, and they can be placed in desirable locations for securing cargo within the bay 1170.

Different hardpoint fittings can be designated for use with different types and sizes of cargos. The illustrated hardpoint fitting 1193 is but one example. In some embodiments, there can be approximately in the range of about 20 hardpoint fittings to about 40 hardpoint fittings within the interior cargo bay 1170, although more or less is possible as well. In alternative embodiments, some portion of the payload can be directly coupled to the hardpoint fittings 1193, rather than via payload-receiving fixtures. A person skilled in the art, in view of the present disclosures, will understand other ways by which a payload can be secured within the interior cargo bay 1170, including by various attachment mechanisms known to those skilled in the art that can be used or otherwise adapted for use with the rail 1174 and/or one or more attachment mechanisms known to those skilled in the art that can be placed in the interior cargo bay and used to secure the location of the payload with respect to the rail 1174 and/or the interior cargo bay 1170 more generally.

The payload-receiving fixture 20 further includes the dynamic load reduction system 38 that can at least be configured to reduce loads and/or mitigate vibrations experienced by the cargo 10 of the aircraft 1000, in particular the lower and upper turbine blades 11A, 11B, as well as other cargos and/or other aircrafts provided for herein or otherwise known to those skilled in the art. Although in alternative embodiments the dynamic load reduction system may be either active, passive, or a combination of an active and passive system, the embodiment of the dynamic load reduction system 38 of FIG. 9 is a passive system. A passive system (shown schematically in FIG. 12) may include the presence of a passive suspension element or elements, such as those described below, between the wind turbine blade and the at least one payload-receiving fixture 22, and, optionally, other devices able to modify the dynamic characteristics of the blade (e.g., tuned vibration dampers and/or tuned vibration absorbers, which may collectively be referred to as tuned load reducers, as described below). The dynamic load reduction system 38 may alter at least one dynamic vibration characteristic of the turbine blades 11A, 11B in response to a dynamic load being experienced, as in a passive system. The at least one dynamic vibration characteristic can be one or more of a vibration frequency, a vibration mode shape, a vibration amplitude, or a vibration damping.

In the illustrated embodiment, a passive system can be utilized to provide a system that naturally reacts to dynamic loads placed on the blades 11A, 11B by the aircraft 1000 without the need to control the system via a computer and/or human. In such a passive system, the dynamic load reduction system 38 may include, but is not limited to, at least one of the following suspension elements: spring-loaded dampers, pneumatic dampers, hydraulic dampers, magnetic eddy current dampers, elastomeric dampers, and the like. The dynamic load reduction system 38 may further include, alternatively to or in addition to the dampers described above, tuned load reducers applied to the surfaces of the blades 11A, 11B.

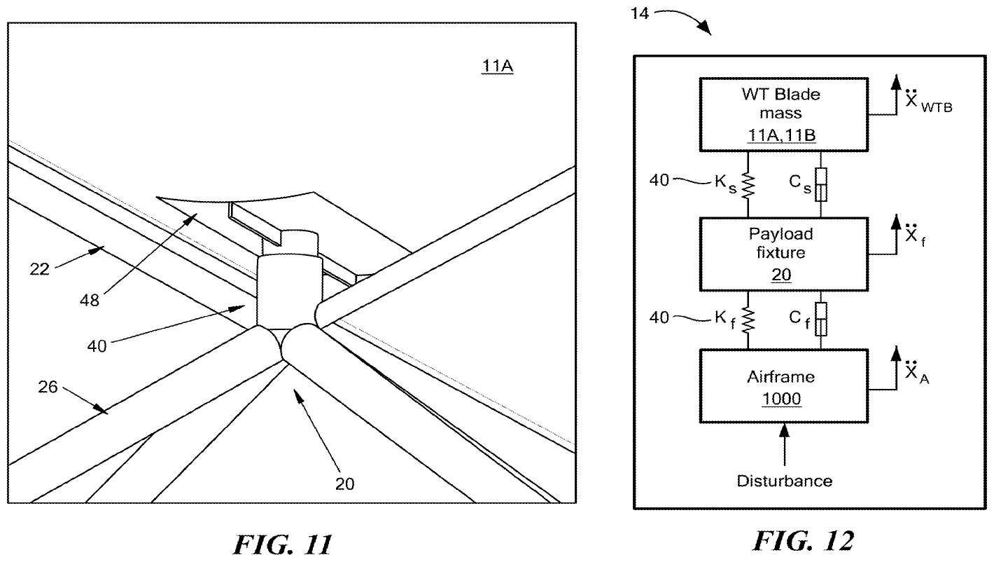

In the illustrated embodiment, the dynamic load reduction system 38 includes a suspension element 40 arranged on the at least one payload-receiving fixture 22 and configured to support the underside of the lower turbine blade 11A, as shown in FIGS. 8-10, and in greater detail in FIG. 11. The suspension element 40 can be arranged on a top side of the lower support frame 23, in particular on top of the two triangular supports 29 each formed by a base support rod 28 and two angled support rods 26. The dynamic load reduction system 38 further includes a surface pad or receiver 48 disposed on an upper portion of the suspension element 40. The surface pad 48 can be configured to move with a movable damping element of the suspension element 40, such as a piston or the like, as described below. The surface pad 48 provides a large contact surface that abuts and supports the underside of the lower blade 11A.

In the illustrated embodiment, a single suspension element 40 is disposed generally centrally under the underside of the lower turbine blade 11A to alter at least one dynamic vibration characteristic of the turbine blade 11B in response to a dynamic load being imparted to the blade 11B by the aircraft 1000. In other embodiments, the dynamic load reduction system 38 may include additional suspension elements 40 disposed in various locations around the frames 23, 24, 80 based on design and structural requirements of the payload-receiving fixture 20, the blades 11A, 11B or other cargo 10, and/or the aircraft 1000 itself, among other factors a person having ordinary skill in the art that would understand can impact the positioning of a component(s) of a dynamic load reduction system in view of the present disclosures. For example, the dynamic load reduction system 38 may include a second suspension element 40 and a second surface pad or receiver 48 arranged on the upper support rod 23U that can be configured to similarly engage with the upper turbine blade 11B and alter at least one dynamic vibration characteristic of the upper turbine blade 11A in response to a dynamic load being imparted to the blade 11A by the aircraft 1000.

FIG. 12 is a schematic diagram of the load management system 14 utilizing the payload-receiving fixture 20 and the dynamic load reduction system 38 provided for herein. The system 14 can include at least one passive suspension element 40 arranged between the turbine blades 11A, 11B and the payload-receiving fixture 20. In the illustrated embodiment, the at least one passive suspension element 40 includes a stiffness element Kₛ, and a damping element Cₛ. The system 38 may optionally include an additional passive suspension element(s) 40 arranged, for example, between the base of the payload-receiving fixture 20 and the aiframe of the aircraft 1000, such as between the rails 1174 and the payload-receiving fixture 20. In the illustrated embodiment, the additional passive suspension element 40 includes a stiffness element K_{f} and a damping element C_{f}.

The symbols \ddot{x}_{A}, \ddot{x}_{f}, \ddot{x}_{WTB} indicate the time derivatives of the displacement (e.g. acceleration in the x-direction) for each of the airframe of the aircraft 1000, the payload-receiving fixture 20, and the blades 11A, 11B, respectively. The inertia forces acting on the aircraft 1000, the payload-receiving fixture 20, and the blades 11A, 11B are of equal forces and opposite direction to the mass x acceleration product. As shown in FIG. 12, a disturbance can be imparted on the airframe of the aircraft 1000, and the disturbance can include vibration frequency, a vibration mode shape, a vibration amplitude, and/or a vibration damping. The vibrations can be damped by the passive suspension elements Kₛ, K_{f}, Cₛ, C_{f}. The purpose of the passive suspension Kₛ, K_{f}, Cₛ, C_{f} is to reduce the accelerations to reduce the inertia loads at the blades 11A, 11B.

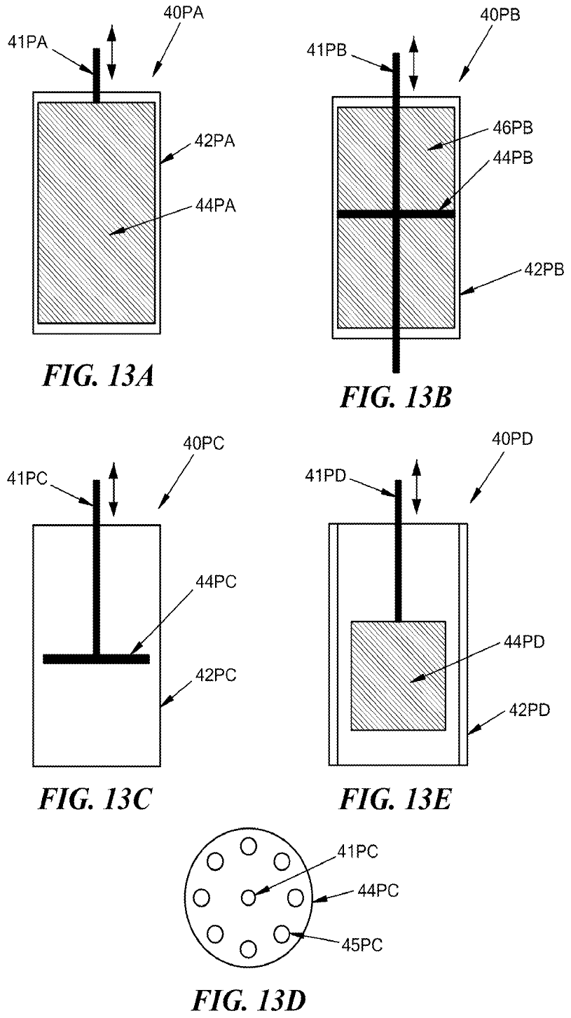

Referring back to the passive suspension element 40, as described above, the passive suspension element 40 may include spring-loaded dampers, pneumatic dampers, hydraulic dampers, magnetic eddy current dampers, and/or elastomeric dampers, and the like. Some non-limiting examples of passive suspension elements are shown and described with respect to FIGS. 11 and 13A-13E. For example, in some embodiments, the passive suspension element 40 may include a friction damper 40PA, as shown in FIG. 13A. The friction damper 40PA can include a movable rod 41PA coupled to a piston 44PA slidably arranged within a hollow cylinder 42PA. The piston 44PA can be sized such that am outer surface of the piston 44PA rubs against the inner surface of the cylinder 42PA. The friction between the piston 44PA and the cylinder 42PA creates resistance, which slows movement of the piston 44PA, thus affecting the movement of the associated turbine blade 11A, 11B. Work done by the piston 44PA can be dissipated as frictional heating.

In some embodiments, the passive suspension element 40 may include an elastomeric damper 40PB, as shown in FIG. 13B. The elastomeric damper 40PB can include a movable rod 41PB coupled to a piston 44PB slidably arranged within a hollow cylinder 42PB. An elastomer 46PB can be arranged within the cylinder 42PB and can resist movement of the piston 44PB. Energy dissipation can be provided by the viscoelastic properties of the elastomer 46PB. The elastomer 46PB may be an elastic material and/or similar material(s) that resist movement of the piston 44PB when arranged around the piston 44PB. In other non-limiting embodiments, the elastomer 46PB may be a spring arranged between the piston 44PB and an end wall of the cylinder 42PB, the spring resisting movement of the piston 44PB. The resistance provided by the piston 44PB can affect the movement of the associated turbine blade 11A, 11B.

In some embodiments, the passive suspension element 40 may include hydraulic damper 40PC, as shown in FIGS. 13C and 13D. The hydraulic damper 40PC can include a movable rod 41PC coupled to a piston plate 44PC slidably arranged within a hollow cylinder 42PC. The cylinder 42PC can be filled with oil and/or other viscous fluid(s). The piston plate 44PC can include a plurality of holes 45PC formed therein, as shown in FIG. 13D, through which fluid within the cavity 42PC can flow. The constricted, turbulent flow of the damping oil/fluid around the piston plate 44PC can provide resistance, thus affecting the movement of the associated turbine blade 11A, 11B. The work done by the piston 44PC on the fluid can be converted to heat.

In some embodiments, the passive suspension element 40 may include magnetic eddy current damper 40PD, as shown in FIG. 13E. The magnetic eddy current damper 40PD can include a movable rod 41PD coupled to a piston 44PD having a permanent magnet slidably arranged within a hollow cylinder 42PD. The walls of the cylinder 42PD can be electrically conductive. Motion of the magnetic piston 44PD can induce electric eddy currents within the conductive cylinder 42PD. The eddy currents can create magnetic fields that oppose the motion of the magnetic piston 44PD, thus affecting the movement of the associated turbine blade 11A, 11B. The eddy current energy can be converted to heat by the resistance of the walls of the conductive cylinder 42PD.

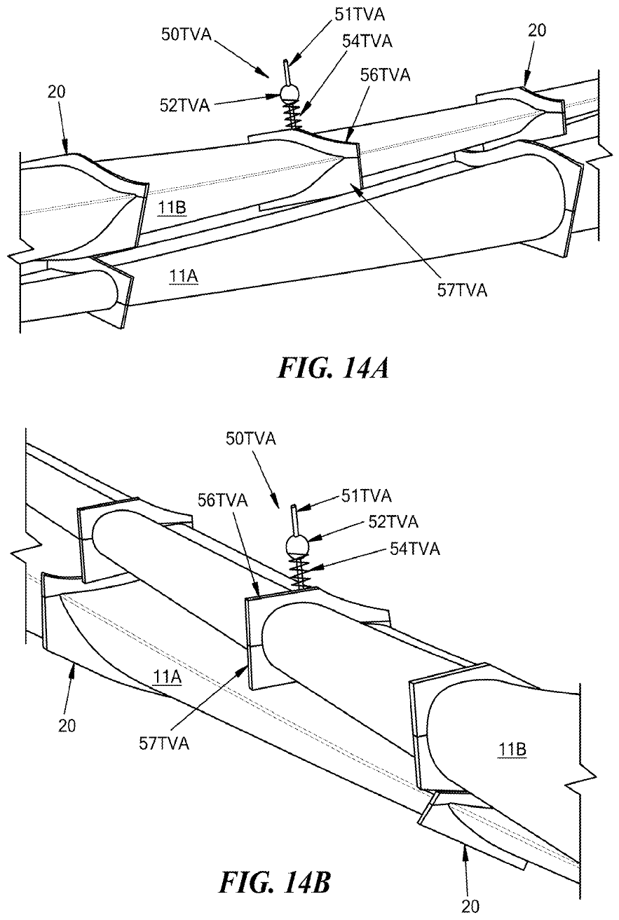

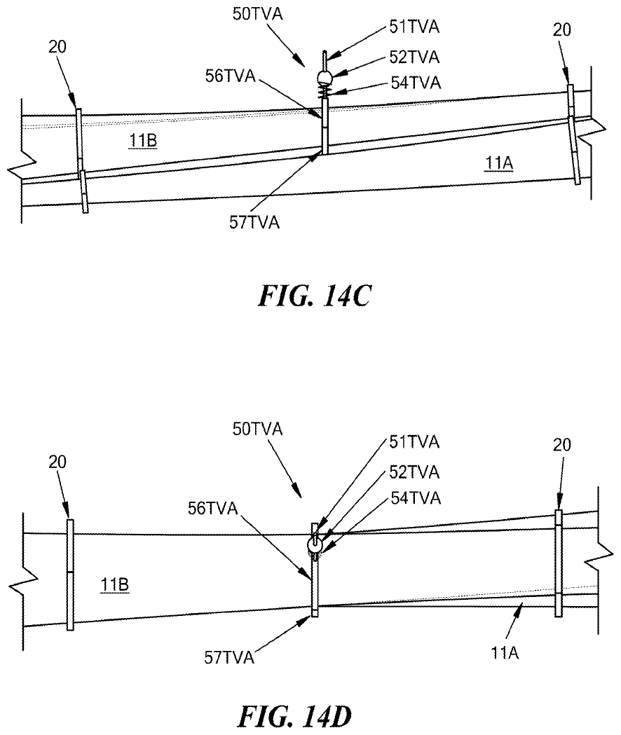

As described above, the dynamic load reduction system 38 may include, in addition to or alternatively to the features described above, tuned load reducers such as tuned vibration dampers and/or tuned vibration absorbers attached to the turbine blades 11A, 11B. For example, in some embodiments, the system 38 can include a tuned vibration absorber 50TVA as shown in FIGS. 14A-14D. The tuned vibration absorber 50TVA can include a guide rod 51TVA and a movable body 52TVA, as shown in this non-limiting instance formed as a sphere, that is movable along the rod 51TVA. The absorber 50TVA can further include an upper clamshell fixture half 56TVA and a lower clamshell fixture half 57TVA that can together couple to the turbine blade 11A, 11B and transfer the vibrations of the blades 11A, 11B to the absorber 50TVA. A spring 54TVA can be arranged between the movable body 52TVA and the upper clamshell fixture half 56TVA. The tuned vibration absorber 50TVA can be provided as part of its own fixture coupled to or otherwise associated with a single blade (e.g., blade 11B) as shown, and/or it can be incorporated to be part of one or more payload-receiving fixtures 20 that are holding multiple blades (e.g., blades 11A, 11B).

The direction of the rod 51TVA can be aligned with the direction of displacement of a natural mode shape of the turbine blade 11A, 11B at the application point of the absorber 50TVA. The location of the tuned vibration absorber 50TVA can be at an antinode of the blade 11A, 11B, for example. The antinode of the blade is the location of maximal displacement under free vibration, which, in the illustrated embodiment, is approximately halfway between support points of the turbine blade 11A, 11B. The support points of the turbine blade 11A, 11B may include, for example, two payload-receiving fixtures 20 arranged in a spaced apart relation along the longitudinal length of the turbine blade 11A, 11B.

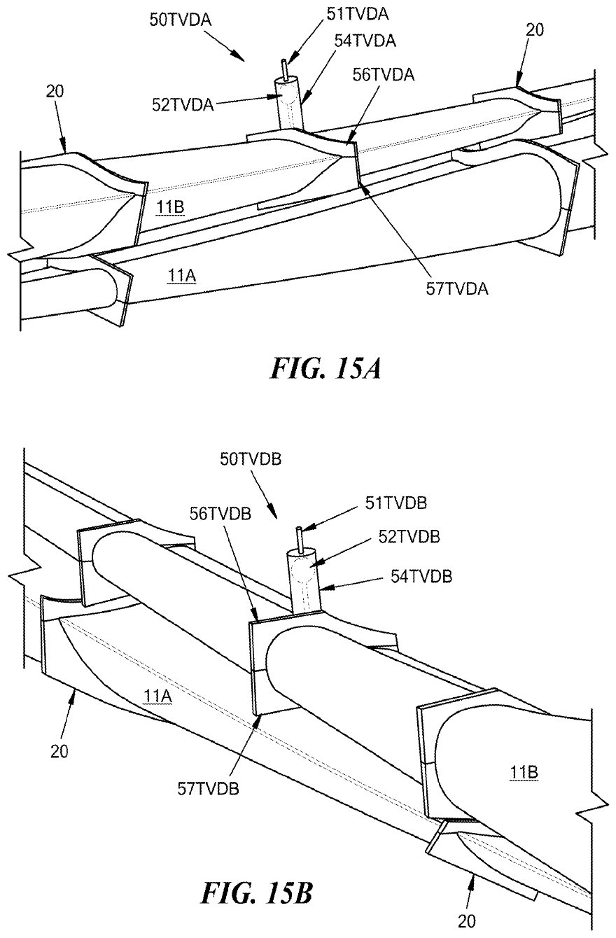

In some embodiments, the system 38 can include a tuned vibration damper 50TVDA as shown in FIG. 15A. The tuned vibration damper 50TVDA can be similar to the tuned vibration absorber 50TVA, in particular including a movable body 52TVDA formed, in the non-limiting illustrated embodiment, as a sphere that can be movable along a guide rod 51TVDA. Unlike the tuned vibration absorber 50TVA, the movable body 52TVDA can be arranged within a cylinder 54TVDA, the cylinder 54TVDA, as shown in the non-limiting illustrated embodiment, being arranged adjacent an upper clamshell fixture half 56TVDA that, together with a lower clamshell fixture half 57TVDA, can couple the damper 50TVDA to the wind turbine blade 11A, 11B. Movement of the movable body 52TVDA can be resisted by a permanent magnet included in the movable body 52TVDA that can interact with an electrically conductive wall of the cylinder 54TVDA. Similar to the magnetic eddy current damper 40PD above, motion of the movable body 52TVDA can induce electric eddy currents within the conductive cylinder 54TVDA. The eddy currents create magnetic fields that can oppose the motion of the movable body 52TVDA, thus affecting the movement of the associated turbine blade 11A, 11B.

In some embodiments, the system 38 can include a tuned vibration damper 50TVDB as shown in FIG. 15B. The tuned vibration damper 50TVDB can include a movable body 52TVDB formed, in the non-limiting illustrated embodiment, as a sphere that can be movable along a guide rod 51TVDB. The movable body 52TVDB can be arranged within a cylinder 54TVDB, the cylinder 54TVDB, as shown in the non-limiting illustrated embodiment, being arranged adjacent an upper clamshell fixture half 56TVDB that, together with a lower clamshell fixture half 57TVDB, can couple the damper 50TVDB to the wind turbine blade 11A, 11B. Movement of the movable body 52TVDB can be resisted by elements similar to those discussed above with the passive suspension elements. For example, the movable body 52TVDB can engage an inner surface of the cylinder 54TVDB such that friction affects the movement of the moveable body 52TVDB, thus affecting the movement of the associated turbine blade 11A, 11B. In other embodiments, springs, hydraulics, and/or pneumatics, or the like may be utilized to provide the damping effect. The tuned vibration dampers 50TVDA, 50TVDB can be provided as part of their own fixtures coupled to or otherwise associated with a single blade (e.g., blade 11B) as shown, and/or they can be incorporated to be part of one or more payload-receiving fixtures 20 that are holding multiple blades (e.g., blades 11A, 11B).

A person skilled in the art will appreciate that dynamic characteristics of each wind turbine blade or blade package can be determined by means of numerical methods (e.g., eigenvalue solutions based on Finite Element Models, from formulas based on first principles or semi-empirical formulas) or by means of static or dynamic testing (e.g., Ground Vibration Testing). As such, characteristics of the passive load reduction system 38, in particular the suspension elements 40 described above, can be tuned to each blade or blade package based on the results of the aforementioned methods. The characteristics may be tuned manually or automatically by a controller based on manual or predictive inputs, such as by the master controller 280 described below. Moreover, the characteristics may be tuned to alter at least one dynamic vibration characteristic of the payload based on a particular phase of aircraft operation such as in-flight, landing, or ground operations.

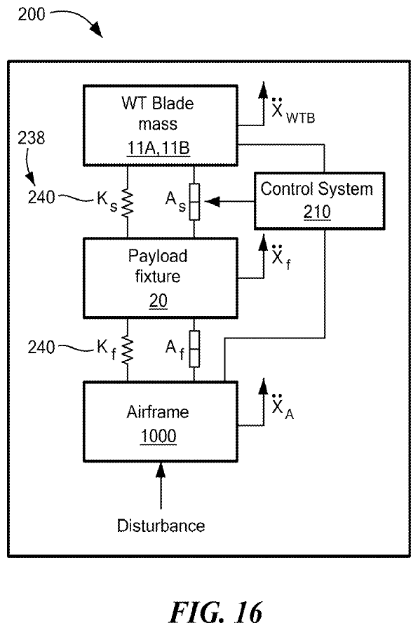

According to an additional aspect of the present disclosure, non-limiting active dynamic load reduction systems 238, and related components, that may be utilized in the payload-receiving fixture(s) 20 are shown and described with respect to FIGS. 16-18. Specifically, the active dynamic load reduction system 238 may be utilized in the payload-receiving fixture 20 in place of the passive dynamic load reduction system 38 described above. The active dynamic load reduction system 238 can be arranged relative to the payload-receiving fixture 20 and the cargo 10, such as the blades 11A, 11B, substantially similarly to the passive dynamic load reduction system 38. The descriptions of the passive dynamic load reduction system 38, as well as the aircraft 1000 and fixture 20, are incorporated by reference to apply to the embodiments including the active dynamic load reduction system 238, except in instances when it conflicts with the specific description and the drawings of the active dynamic load reduction system 238. Any combination of the components of the aircraft 1000, the payload-receiving fixture(s) 20, the passive dynamic load reduction system 38, and the active dynamic load reduction system 238 described in further detail below may be utilized in conjunction with any of the embodiments provided for herein or otherwise derivable from the present disclosure.

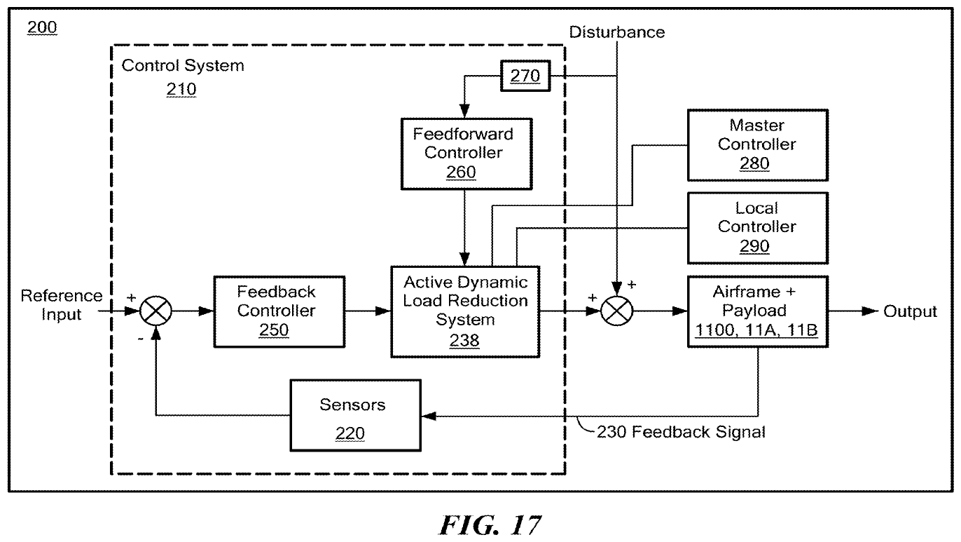

FIG. 16 is a schematic diagram of an arrangement utilizing the payload-receiving fixture 20 and the active dynamic load reduction system 238. The active dynamic load redution system 238 can be part of a control system 210 of an aircraft load management system 200 (shown schematically in FIG. 17), which will be described in greater detail below. The arrangement can include at least one active suspension element 240 arranged between the turbine blades 11A, 11B and the payload-receiving fixture 20. In the illustrated embodiment, the at least one passive suspension element 240 includes a stiffness element Kₛ and an active suspension element A. The system 238 may optionally include an additional active suspension elements arranged between the base of the payload-receiving fixture 20 and the aiframe of the aircraft 1000, such as between the rails 1174 and the payload-receiving fixture 20. In the illustrated embodiment, the at least one passive suspension element 240 includes a stiffness element K_{f} and an active suspension element A_{f}.

The symbols \ddot{x}_{A}, \ddot{x}_{f}, \ddot{x}_{WTB} indicate the time derivatives (acceleration in the x-direction) for each of the airframe of the aircraft 1000, the payload-receiving fixture 20, and the blades 11A, 11B, respectively. The inertia forces acting on the aircraft 1000, the payload-receiving fixture 20, and the blades 11A, 11B can be of equal forces and opposite direction to the mass x acceleration product. As shown in FIG. 16, a disturbance can be imparted on the airframe of the aircraft 1000, and the disturbance can include vibration frequency, a vibration mode shape, a vibration amplitude, and/or a vibration damping. As will be described in greater detail below, the control system 210 of the aircraft load management system 200 can be configured to actively and predictively mitigate vibrations, for example, via the active suspension elements 240 Kₛ, K_{f}, Aₛ, A_{f}. The purpose of the passive suspension Kₛ, K_{f}, Aₛ, A_{f} is to reduce the accelerations to reduce the inertia loads at the blades 11A, 11B.

The aircraft load management system 200 can include the control system 210 as well as the aircraft 1000 and payload (i.e., the cargo 10 housed within the aircraft 1000, the cargo being two wind turbine blades 11A, 11B in the present embodiment). In the illustrated embodiment, the control system 210 includes the active dynamic load reduction system 238, at least one sensor 220, a closed loop active feedback controller 250, and an open or closed loop active feedforward controller 260, as shown in FIG. 17. In other non-limiting embodiments, the control system 210 only includes one of the active feedback controller 250 and the active feedforward controller 260. The active dynamic load reduction system 238 may alter at least one dynamic vibration characteristic of the turbine blades 11A, 11B in response to an expected or predicted dynamic load being imparted on the turbine blades 11A, 11B by the airframe, for example from turbulence or other disturbances.

The control system 210 can be configured to actively respond to disturbances occurring in the system 200, in particular occurring to the aircraft 1000 and the turbine wind blades 11A, 11B housed therein, and/or predictively respond to disturbances that will occur to the aircraft 1000 and the turbine wind blades 11A, 11B. In this way, vibrational responses that may potentially affect the wind turbine blades 11A, 11B can be mitigated or eliminated. In order to carry out the active and predictive load reduction commands issued by the feedback and feedforward controllers 250, 260, the active dynamic load reduction system 238 can include at least one suspension element 240 or elements 240, such as those described below, between the wind turbine blade 11A, 11B and the at least one payload-receiving fixture frame 22 of the payload-receiving fixture 20. Optionally, other devices may be included to modify the dynamic characteristics of the blade (i.e., tuned vibration dampers and/or tuned vibration absorbers as described above). The active dynamic load reduction system 238 can alter at least one dynamic vibration characteristic of the turbine blades 11A, 11B including one or more of a vibration frequency, a vibration mode shape, a vibration amplitude, or a vibration damping.

The control system 210 can include at least one sensor 220 in operable engagement with the airframe of the aircraft 1000, the fixture assemblies 20, and/or the turbine blades 11A, 11B, as well as operably connected to the feedback controller 250, as shown in FIG. 17. The at least one sensor 220 can be configured to measure at least one operating disturbance of the aircraft 1000, the fixture assemblies 20, and/or the turbine blades 11A, 11B (shown as a feedback signal 230 in FIG. 17), and inform the feedback controller 250 of the disturbance. The at least one sensor 220 may include one or more devices measuring the disturbance and/or the response of the aircraft 1000, the fixture assemblies 20, and/or the turbine blades 11A, 11B, such as acceleration, displacement, and/or reaction force. Other disturbances may include, but are not limited to, payload displacement, payload acceleration, payload-receiving fixture acceleration, airframe acceleration, aircraft instruction from a pilot, aircraft instruction from an electronic flight control system, atmospheric turbulence data, runway roughness, and/or wind gust data. The device or devices may include, but are not limited to, accelerometers, gyroscopes, potentiometers, load cells, and/or strain gauges. The at least one sensor 220 or sensors 220 may be appropriately placed on the wind turbine blades 11A, 11B, on the fixture assemblies 20, and/or on the airframe of the aircraft 1000.

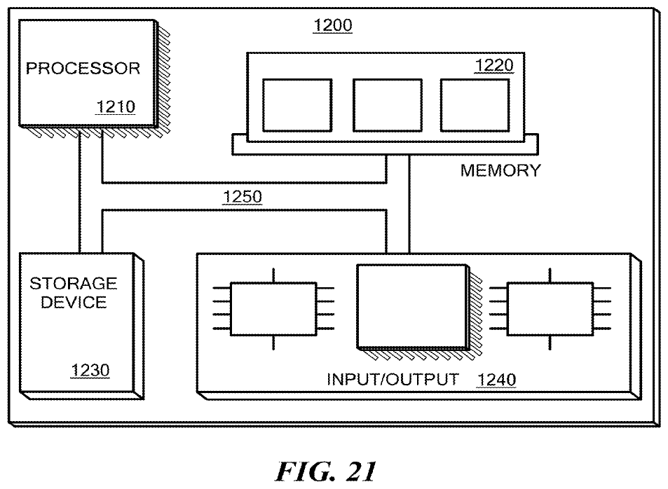

The control system 210 can further include at least one of a feedback controller 250 and/or a feedforward controller 260. In the illustrated embodiment, the control system 210 includes a feedback and a feedforward controller 250, 260. Each controller 250, 260 can be a processing device in which control laws are defined. Control laws defined in the controller can be as simple as an industrial PID (Proportional-Integral-Derivative) controller or a more complex system like a Model Predictive Controller. The controllers 250, 260 may be digital and/or analogic. Control laws logic may be either feedforward, feedback, or a combination of the two. One or more of the controllers 250, 260 may be integrated into one or more of the fixture assemblies 20, also known as payload-receiving fixtures. Each controller described herein, such as the controllers 250, 260, may include at least one processor connected to a computer readable memory and/or other data storage. Computer executable instructions and data used by a processor may be stored in the computer readable memory included in an onboard computing device, a remote server, a combination of both, or implemented with any combination of read only memory modules or random-access memory modules, optionally including both volatile and nonvolatile memory. In particular, each controller described herein may be utilized with the computer system 1200 described in further detail below and with reference to FIG. 21.

The feedback controller 250 can be configured to provide active feedback in response to the system 200 experiencing disturbances measured by the at least one sensor 220. The at least one sensor 220 can be arranged on the turbine blades 11A, 11B, the payload-receiving fixture(s) 20, and/or the aircraft 1000. The feedback controller 250 can further be configured to utilize a reference set point, or reference input (also referred to as a predictive disturbance input or inputs, which can also include disturbance input signals) to actively respond to disturbances in the system 200 and instruct the active dynamic load reduction system 238 to activate and respond accordingly. In particular, corrective action can be taken as soon as, or shortly thereafter (e.g., within a few hundredths of a second or faster, considering the dynamics of the system are characterized by normal modes starting at 1 Hz) the disturbance variable is determined to have deviated from the set point, or reference input. The reference inputs may include, but are not limited to, (i) displacements of a set of points on the turbine blades 11A, 11B, (ii) accelerations of a set of points on the turbine blades 11A, 11B, fixture assemblies 20, and/or the airframe of the aircraft 1000, (iii) command inputs, i.e., aircraft main control surface commands from the pilot or the electronic flight control system, such as fly-by-wire systems, (iv) sensors sensing atmospheric turbulence or gusts ahead of the flight path of the aircraft, such as LIDAR systems, and/or (v) field or runway roughness during taxing and/or landing, and/or additional data from a surrounding environment of the aircraft that may impact the load exerted on the payload by the airframe of the aircraft 1000.

The feedforward controller 260, as opposed to the feedback controller 250 providing active, reactionary feedback, can be configured to provide predictive feedback in response to the system 200 experiencing disturbances measured by the at least one sensor 220. In particular, the control system 210 can include additional sensors 270 operably engaged with one or more of the aircraft 1000, the payload-receiving fixtures 20, the turbine blades 11A, 11B, and/or the surrounding environment that actively measure, for example, disturbance variables of these components or the surrounding environment. The feedforward controller 260 can contain a mathematical model of the aircraft 1000, fixtures 20, blades 11A, 11B, and elements of the dynamic load reduction system 238. The model can be, for example, a polynomial or a linear system. Inputs for the model can be those measured by sensor(s) 270. The logic can be different from the feedback controller 250 at least because the external input disturbance can be processed directly, producing a response by the elements of the dynamic load reduction system 238, and no feedback can be measured.

The feedforward controller 260 may also operate by utilizing already known information regarding the components of the aircraft 1000 and the surrounding environment, such as data from satellites, maps, weather forecasting systems, airport data, and the like. From this information, the feedforward controller 260 can determine a current operating condition of the turbine blades 11A, 11B and can evaluate this operating condition, for example by comparing the condition with a reference value or values, to determine whether the turbine blades 11A, 11B will experience undesirable vibrational responses and loading as a result of the current operating condition. In response to a determination that undesirable vibrational experiences will be experienced by the blades 11A, 11B, also referred to as an expected dynamic load on the payload, the feedforward controller 260 can be configured to instruct the active dynamic load reduction system 238 to activate and exert a force on the payload, thus mitigating the responses experienced by the blades 11A, 11B.

The dynamic characteristics of each wind turbine blade or blade package, as well as dynamic characteristics of the airframe of the aircraft 1000, the payload-receiving fixture 20, can be predictively determined by means of numerical methods (e.g., eigenvalue solutions based on Finite Element Models, from formulas based on first principles or semi-empirical formulas) or by means of static or dynamic testing (e.g., Ground Vibration Testing). More generally, a predictive disturbance input can be any data, command, signal, or the like that, taken alone or in combination with other data, commands, signals, etc., that may impact the load exerted on the turbine blades 11A, 11B by the airframe of the aircraft 1000.

In an exemplary scenario that illustrates the difference between the feedback controller 250 and the feedforward controller 260, the feedforward controller 260 comprises a mathematical model of any form (e.g. polynomial, linear system, etc.) representing the force or displacement to be applied to the blades 11A, 11B for a known force or acceleration at the nose landing gear 123 of the aircraft 1000 to minimize the response of the blades 11A, 11B. The model can be predetermined, for example by a study in which the response of the blade 11A, 11B is determined or otherwise known by analysis (e.g., finite element models or any other appropriate mathematical method) and/or by testing.

Output from the controllers 250, 260 can be signals or instructions to the active dynamic load reduction system 238 commanding an enforced displacement or a force. Additionally, or alternatively, the controllers 250, 260 may output signals or instructions to at least one user of the aircraft 1000. The signals or instructions output to the user can include information regarding a recommended displacement or a force to be applied to the turbine blades 11A, 11B via the active dynamic load reduction system 238 to reduce or otherwise respond to aircraft disturbances and/or dynamic loads resulting therefrom. The purpose of the information is to provide data to the user and enable tuning of the system. The information can include information regarding the response of the system, including its inputs from the sensors and/or output to the actuators, such that the user can modify the systems parameters (e.g., gains) to reduce the dynamic loads at the blades 11A, 11B. A user can be a human user, i.e., a pilot, technician, or other person monitoring the cargo 10 of the aircraft 1000, or a device, such as a robot or another controller.

In some embodiments, a first controller 280, also referred to as a master controller 280, can be integrated into the aircraft control panel or another electronic device, such as a laptop, tablet, phone, etc. The controller can be connected to a display such that the output can be visually communicated to one or more user. One or more second controllers 290, also referred to as local controllers 290, can be integrated into one or more of the airframe of the aircraft 1000, the fixture assemblies 20, and/or the turbine blades 11A, 11B. The master controller 280 can receive transmissions of signals or instructions from one or more of the local controllers 290 and, in some embodiments, can coordinate control of one or more suspension elements 240 of the active dynamic load reduction system 238 associated with the turbine blades 11A, 11B based on aggregated output from the local controllers 290.

In the aircraft load management system 200, the active dynamic load reduction system 238 can comprise an active suspension element 240 that includes, but is not limited to, at least one of hydraulic actuators, pneumatic actuators, solenoid actuators, and/or similar linear actuators. The active suspension element 240 can engage with, for example, the underside of one of the turbine blades 11A, 11B to dynamically reduce loads experienced by the blade 11A, 11B.

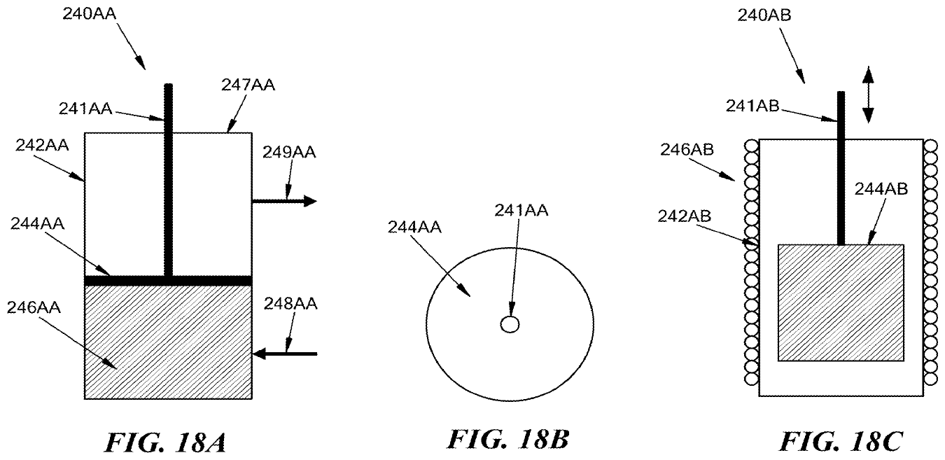

For example, in some embodiments, the active suspension element 240 can include a hydraulic actuator 240AA, as shown in FIGS. 18A and 18B. The hydraulic actuator 240AA can include a movable rod 241AA coupled to a piston plate 244AA slidably arranged within a hollow cylinder 242AA. The piston plate 244AA can be sized such that the outer surface of the piston plate 244AA is fluid-tight against the inner surface of the cylinder 242AA. The cylinder 242AA can be filled with fluid in a lower portion 246AA below the piston plate 244AA and an upper portion 247AA above the piston plate 244AA. Pressurized fluid can be fed into either the lower and/or upper portions 246AA, 247AA to raise and lower the piston plate 244AA, and in turn raise and lower the movable rod 241AA. For example, in FIG. 18A, a feed line 248AA can supply pressurized fluid to the lower portion 246AA while a release line 249AA can allow fluid to drain from the upper portion 247AA such that the piston 244AA and rod 241AA can move upwardly. Fluid can be configured to be rapidly supplied and/or rapidly removed, thus precisely affecting the movement of the associated turbine blade 11A, 11B in response to inputs by one or more of the controllers 250, 260, 280, 290.

In some embodiments, the active suspension element 240 can include a solenoid actuator 240AB, as shown in FIG. 18C. The solenoid actuator 240AB can include a movable rod 241AB coupled to a magnetically permeable armature 244AB slidably arranged within a hollow cylinder 242AB. The cylinder 242AB can be surrounded by a solenoid coil 246AB. Applying electric current to the solenoid coil 246AB can create an axial magnetic field. The interaction of the axial magnetic field with the magnetically permeable armature 244AB can create a force on the armature 244AB, thus moving the armature 244AB and the rod 241AB. The armature 244AB can be configured to be rapidly moved via the magnetic field, thus precisely affecting the movement of the associated turbine blade 11A, 11B in response to inputs by one or more of the controllers 250, 260, 280, 290.

A person skilled in the art will appreciate that dynamic characteristics of each wind turbine blade or blade package can be determined by means of numerical methods (e.g., eigenvalue solutions based on Finite Element Models, from formulas based on first principles or semi-empirical formulas) and/or by means of static or dynamic testing (e.g., Ground Vibration Testing). As such, characteristics of the active load reduction system 238, in particular the suspension elements 240 described above, can be tuned to each blade or blade package based on the results of the aforementioned methods. The characteristics may be tuned manually or automatically by a controller based on manual or predictive inputs, such as by the master controller 280 described above. Moreover, the characteristics may be tuned to alter at least one dynamic vibration characteristic of the payload based on a particular phase of aircraft operation such as in-flight, landing, or ground operations.

Parameters of the control system 210 can be tuned by changing the gains of one or more of the controllers 250, 260, 280, 290. Gain values can be preset, previously calculated by means of numerical analysis, or by testing, and/or can be modified adaptively in operation by measuring the response of the system and calculating a set of parameters minimizing the response. The gains can be tuned for a particular operational phase of the aircraft, such as flight, landing, and/or ground operations. Moreover, the gains can be tuned for a particular payload and/or payload package. The gains can also be adjusted during operation of the aircraft based, at least in part, on a dynamic response of the payload.

One purpose of the aircraft load management system can be to minimize the response of the payload, in particular the turbine blades 11A, 11B, under external disturbances by introducing forces to the turbine blades 11A, 11B through a set of control systems, actuators, varying in time according to a profile determined by one or more of the controllers 250, 260, 280, 290, and/or equivalent components, sensors, known to those skilled in the art that such person having skill in the art would know how to incorporate to be part of the systems and methods described herein in view of the present disclosures. The profile determined by one or more of the controllers 250, 260, 280, 290 may be based, at least in part, on the operational stage of the aircraft, i.e., in-flight, landing, and/or ground operations.

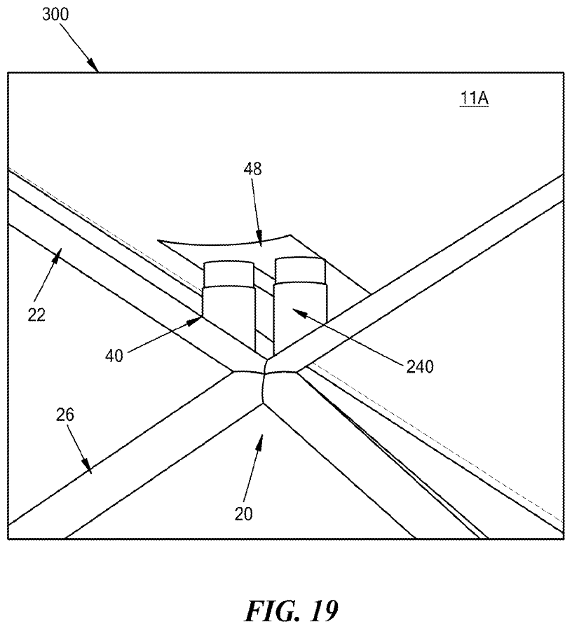

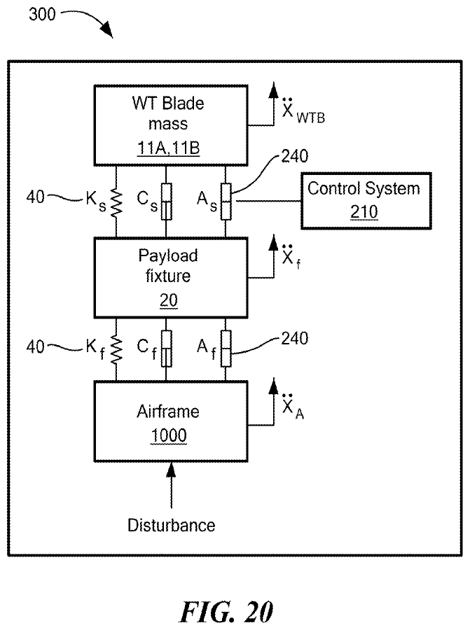

According to an additional aspect of the present disclosure, an active dynamic load reduction system 238, in particular at least one active suspension element 240, can be utilized in a load management system 300 along with a passive dynamic load reduction system 38, in particular a passive suspension element 40, as shown in FIGS. 19 and 20. The active suspension element 240 and the passive suspension element 40 can each be arranged relative to the payload-receiving fixture 20 and the cargo 10, in particular the blades 11A, 11B, substantially similarly to the arrangements described above. The descriptions of the passive dynamic load reduction system 38, as well as the aircraft 1000 and fixture 20, are incorporated by reference to apply to the embodiments including the load management system 300, except in instances when it conflicts with the specific description and the drawings of the load management system 300. Any combination of the components of the aircraft 1000, the payload-receiving fixture 20, the passive dynamic load reduction system 38, and the active dynamic load reduction system 238 described in further detail below may be utilized in an assembly of the present disclosure.

For example, an active suspension element 240, as described above, can be mounted in parallel with a passive suspension element 40, as shown in FIG. 19. Specifically, the active suspension element 240 and the passive suspension element 40 can be arranged on the top side of the lower support frame 23, in particular on top of the two triangular supports 29 each formed by the base support rod 28 and the two angled support rods 26 (see FIG. 8). The active suspension element 240 and the passive suspension element 40 can each engage an underside of the lower turbine blade 11A. Such a configuration can provide for failsafe and/or performance enhancement of the load management system 300. FIG. 20 shows this system 300 schematically similar to FIGS. 15 and 16, in particular showing that the system 300 may include additional elements 40, 240 between the payload-receiving fixture 20 and the airframe of the aircraft 1000.

A person skilled in the art would understand that the systems 14, 200, 300 described herein may include additional suspension elements 40, 240, in addition to those described above, disposed around different locations of the payload-receiving fixture 20 based, at least in part, on the structural requirements of the cargo 10 being carried in the aircraft 1000 and/or the requirements of the aircraft 1000 itself. The systems 14, 200, 300 may also include a combination of the same passive suspension elements 40, a combination of the same passive suspension elements 40 and the same active suspension elements 240, a combination of differing passive suspension elements 40 and the same active suspension elements 240, a combination of the same passive suspension elements 40 and differing active suspension elements 240, and/or a combination of differing passive suspension elements 40 and differing active suspension elements 240. Likewise, a person skilled in the art, in view of the present disclosure, will understand other components that can be implemented to perform the functions of the components of the systems 14, 200, 300 provided for herein, including but not limited to active suspension provided by means of a piezoelectric actuator. Moreover, passive suspension may be provided by viscoelastic dampers, materials with hysteresis, internal frictions, and/or film-squeeze dampers. Springs may include but are not limited to coils, solid linear or torsional elements, bending elements such as leaf springs, wave springs, or disc springs, and/or other similarly performing devices known to those skilled in the art.

FIG. 21 is a block diagram of one exemplary embodiment of a computer system 1200 upon which the present disclosures can be built, performed, trained, etc. For example, referring to FIGS. 7 to 20, any modules, controllers, or systems can be examples of the system 1200 described herein, for example the controllers 250, 260, 280, 290 and any of the associated routines described therein. The system 1200 can include a processor 1210, a memory 1220, a storage device 1230, and an input/output device 1240. Each of the components 1210, 1220, 1230, and 1240 can be interconnected, for example, using a system bus 1250. The processor 1210 can be capable of processing instructions for execution within the system 1200. The processor 1210 can be a single-threaded processor, a multi-threaded processor, or similar device. The processor 1210 can be capable of processing instructions stored in the memory 1220 or on the storage device 1230. The processor 1210 may execute operations such as providing active feedback in response to the system 200 experiencing disturbances measured by the at least one sensor 220, providing predictive feedback in response to the system 200 experiencing disturbances measured by the at least one sensor 220, determining a current operating condition of the turbine blades 11A, 11B, evaluating this operating condition, for example by comparing the condition with a reference value or values, to determine whether the turbine blades 11A, 11B will experience undesirable vibrational responses and loading as a result of the current operating condition, instructing the active dynamic load reduction system 238 to activate and exert a force on the payload, among other features described in conjunction with the present disclosure.

The memory 1220 can store information within the system 1200. In some implementations, the memory 1220 can be a computer-readable medium. The memory 1220 can, for example, be a volatile memory unit or a non-volatile memory unit. In some implementations, the memory 1220 can store information related to wind turbine blades and cargo bays, aircraft surroundings and environment data, among other information.

The storage device 1230 can be capable of providing mass storage for the system 1200. In some implementations, the storage device 1230 can be a non-transitory computer-readable medium. The storage device 1230 can include, for example, a hard disk device, an optical disk device, a solid-date drive, a flash drive, magnetic tape, and/or some other large capacity storage device. The storage device 1230 may alternatively be a cloud storage device, e.g., a logical storage device including multiple physical storage devices distributed on a network and accessed using a network. In some implementations, the information stored on the memory 1220 can also or instead be stored on the storage device 1230.

The input/output device 1240 can provide input/output operations for the system 1200. In some implementations, the input/output device 1240 can include one or more of network interface devices (e.g., an Ethernet card or an Infmiband interconnect), a serial communication device (e.g., an RS-232 10 port), and/or a wireless interface device (e.g., a short-range wireless communication device, an 802.7 card, a 3G wireless modem, a 4G wireless modem, a 5G wireless modem). In some implementations, the input/output device 1240 can include driver devices configured to receive input data and send output data to other input/output devices, e.g., a keyboard, a printer, and/or display devices. In some implementations, mobile computing devices, mobile communication devices, and other devices can be used.

In some implementations, the system 1200 can be a microcontroller. A microcontroller is a device that contains multiple elements of a computer system in a single electronics package. For example, the single electronics package could contain the processor 1210, the memory 1220, the storage device 1230, and/or input/output devices 1240.

Although an example processing system has been described above, implementations of the subject matter and the functional operations described above can be implemented in other types of digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible program carrier, for example a computer-readable medium, for execution by, or to control the operation of, a processing system. The computer readable medium can be a machine-readable storage device, a machine-readable storage substrate, a memory device, a composition of matter effecting a machine-readable propagated signal, or a combination of one or more of them.

Various embodiments of the present disclosure may be implemented at least in part in any conventional computer programming language. For example, some embodiments may be implemented in a procedural programming language (e.g., “C” or ForTran95), or in an object-oriented programming language (e.g., “C++”). Other embodiments may be implemented as a pre-configured, stand-along hardware element and/or as preprogrammed hardware elements (e.g., application specific integrated circuits, FPGAs, and digital signal processors), or other related components.

The term “computer system” may encompass all apparatus, devices, and machines for processing data, including, by way of non-limiting examples, a programmable processor, a computer, or multiple processors or computers. A processing system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, executable logic, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Such implementation may include a series of computer instructions fixed either on a tangible, non-transitory medium, such as a computer readable medium. The series of computer instructions can embody all or part of the functionality previously described herein with respect to the system. Computer readable media suitable for storing computer program instructions and data include all forms of non-volatile or volatile memory, media and memory devices, including by way of example semiconductor memory devices, e.g., EPROM, EEPROM, and flash memory devices; magnetic disks, e.g., internal hard disks or removable disks or magnetic tapes; magneto optical disks; and CD-ROM and DVD-ROM disks. The processor and the memory can be supplemented by, or incorporated in, special purpose logic circuitry. The components of the system can be interconnected by any form or medium of digital data communication, e.g., a communication network. Examples of communication networks include a local area network (“LAN”) and a wide area network (“WAN”), e.g., the Internet.

Those skilled in the art should appreciate that such computer instructions can be written in a number of programming languages for use with many computer architectures or operating systems. Furthermore, such instructions may be stored in any memory device, such as semiconductor, magnetic, optical, or other memory devices, and may be transmitted using any communications technology, such as optical, infrared, microwave, or other transmission technologies.

Among other ways, such a computer program product may be distributed as a removable medium with accompanying printed or electronic documentation (e.g., shrink-wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud-computing model. Of course, some embodiments of the present disclosure may be implemented as a combination of both software (e.g., a computer program product) and hardware. Still other embodiments of the present disclosure are implemented as entirely hardware, or entirely software.

While the illustrations and descriptions herein are with particular reference to an aircraft, the principles of the present disclosure are not limited to aircrafts and can be applied to other modes of transporting large payloads (e.g., ships). Furthermore, while the illustrations and descriptions herein are with particular reference to a payload including two wind turbine blades, the principles of the present disclosure are not limited to such payloads and can include any number of turbine blades or other large/elongate payloads. A payload may be considered elongate when one dimension (e.g., length) greatly exceeds the others (e.g., width and height).

Some non-limiting examples of the above-described embodiments can include the following:

1. A system for alleviating dynamic loads on a payload, comprising:
at least one payload-receiving fixture configured to receive a payload and couple the payload to an airframe within an interior cargo bay of an aircraft; and
a dynamic load reduction system including at least one suspension element associated with at least one of the payload or the at least one payload-receiving fixture, the dynamic load reduction system configured to alter at least one dynamic vibration characteristic of the payload when the payload is associated with the at least one payload-receiving fixture and coupled to the airframe such that a dynamic load exerted by the airframe on the payload is reduced.
   2. The system of claim 1, wherein the at least one dynamic vibration characteristic is one or more of a vibration frequency, a vibration mode shape, a vibration amplitude, or a vibration damping.
   3. The system of claim 1 or 2, further comprising a payload configured to be received by the at least one payload-receiving fixture.
   4. The system of claim 3, wherein the at least one payload-receiving fixture includes a plurality of payload-receiving fixtures placed with respect to the payload to minimize the dynamic load exerted on the payload.
   5. The system of claim 3, wherein the at least one payload-receiving fixture includes a plurality of payload-receiving fixtures placed with respect to the payload to at least one of reduce payload deflection or prevent the payload from vibrating at a natural vibration frequency of the payload.
   6. The system of claim 3 or 4, wherein the payload comprises at least one elongate member that exhibits natural vibration frequencies within a range of frequency typically excited by a cargo aircraft during at least one of flight, landing, or ground operations.
   7. The system of any of claims 3 to 6, wherein the payload comprises one or more components of a wind turbine.
   8. The system of any of claims 1 to 7,
wherein the at least one suspension element comprises at least one actuator, and
wherein the dynamic load reduction system further comprises a controller configured to:
   (1) receive at least one predictive disturbance input; and
   (2) output, based on the at least one predictive disturbance input, one or more instructions to activate the at least one actuator in response to an expected dynamic load on the payload.
      9. The system of claim 8, wherein the at least one actuator comprises a linear actuator.
      10. The system of claim 8 or 9, wherein the one or more instructions output by the controller instructs the at least one actuator to at least one of displace the payload or exert a force on the payload.
      11. The system of any of claims 8 to 10, wherein the controller is further configured to actuate the at least one actuator in accordance with the at least one instruction.
      12. The system of any of claims 8 to 11, wherein the controller is further configured to transmit the at least one instruction to a user.
      13. The system of any of claims 8 to 12, wherein the controller is integrated into one or more payload-receiving fixtures of the at least one payload-receiving fixture.
      14. The system of any of claims 8 to 12, further comprising:
a cargo aircraft,
wherein the controller is integrated into a control system of the cargo aircraft.
   15. The system of any of claims 8 to 14, wherein the at least one predictive disturbance input is received from at least one sensor located on one or more of the payload, the at least one payload-receiving fixture, or the aircraft.
   16. The system of any of claims 8 to 15, wherein the at least one predictive disturbance input comprises one or more of a payload displacement, payload acceleration, payload-receiving fixture acceleration, airframe acceleration, aircraft instruction from a pilot, aircraft instruction from an electronic flight control system, atmospheric turbulence data, runway roughness, or wind gust data.
   17. The system of claim 16:
wherein the at least one predictive disturbance input includes at least one of the aircraft instruction from the pilot or the aircraft instruction from the electronic flight system, and
wherein the aircraft instruction from the pilot or the aircraft instruction from the electronic flight system pertains to at least one of an aircraft operation or environmental condition capable of causing an external disturbance to the payload.
   18. The system of any of claims 8 to 17, wherein the controller comprises a feedforward controller, a feedback controller, or a combination thereof.
   19. The system of any of claims 8 to 18, wherein the controller is configured to process the at least one predictive disturbance inputs through one or more gains to generate the at least one instruction.
   20. The system of claim 19, wherein one or more of the one or more gains are tuned for a particular operational phase of the aircraft.
   21. The system of claim 20, wherein the particular operational phase is one of in flight, landing, or ground operations.
   22. The system of any of claims 19 to 21, wherein one or more of the one or more gains are tuned for a particular payload or payload package.
   23. The system of any of claims 19 to 22, wherein one or more of the one or more gains are adjusted during operation of the aircraft based on a dynamic response of the payload.
   24. The system of any of claims 1 to 23, wherein the at least one suspension element of the dynamic load reduction system comprises a spring-and-damper system coupled to one payload-receiving fixture of the at least one payload-receiving fixture and configured to couple to the payload received therein.
   25. The system of claim 24, wherein the at least one the spring-and-damper system is mounted in parallel with at least one actuator.
   26. The system of claim 24 or 25, wherein the dynamic load reduction system further comprises one or more tuned load reducers configured to be applied to a surface of the payload to further modify the at least one dynamic characteristic of the payload.
   27. The system of claim 26, wherein the one or more tuned load reducers comprises at least one of a tuned vibration absorber or a tuned mass damper.
   28. The system of any of claims 24 to 27, wherein the at least one suspension element is configured to be tuned manually.
   29. The system of any of claims 24 to 28, wherein the at least one suspension element is configured to be tuned automatically.
   30. The system of any of claims 1 to 29, wherein the dynamic load reduction system is configured to be tuned to alter the at least one dynamic vibration characteristic of the payload based on a particular phase of aircraft operation.
   31. The system of claim 30, wherein the particular phase of aircraft operation is one of in-flight, landing, or ground operations.
   32. The system of any of claims 1 to 31, wherein the dynamic load reduction system is configured to be tuned to alter the at least one dynamic vibration characteristic of the payload based on at least one of a particular type or characteristic of a payload.
   33. The system of any of claims 1 to 32, further comprising a cargo aircraft having an interior cargo bay with a forward bay portion located in a forward end of the cargo aircraft and an aft bay portion located in an aft end of the cargo aircraft.
   34. The system of claim 33, wherein the interior cargo bay of the cargo aircraft further comprises a kinked bay portion disposed between the forward bay portion and the aft bay portion, the kinked bay portion defining a location at which the aft end of the cargo aircraft begins to raise relative to a longitudinal-lateral plane of the cargo.
   35. The system of claim 34, wherein the at least one payload-receiving fixture is configured to couple to the airframe within the interior cargo bay such that the payload extends from the forward bay portion, through the kinked bay portion, and into the aft bay portion of the interior cargo bay.
   36. A method of managing a payload within an interior cargo bay of a cargo aircraft, comprising:
altering at least one dynamic vibration characteristic of a payload coupled to an airframe of the cargo aircraft by way of one or more payload-receiving fixtures within an interior cargo bay of the cargo aircraft,
wherein altering the at least one dynamic characteristic of the payload occurs in response to a dynamic load being exerted by the airframe on the payload while the aircraft is at least one of in flight, landing, or performing ground operations.
   37. The system of claim 36, wherein the at least one dynamic vibration characteristic is one or more of a vibration frequency, a vibration mode shape, a vibration amplitude, or a vibration damping.
   38. The method of claim 36 or 37, wherein the cargo aircraft further comprises at least one actuator associated with at least one of the payload or at least one payload-receiving fixture of the one or more payload-receiving fixtures, and wherein the method further comprises:
receiving, by a controller, at least one predictive disturbance input from one or more sensors;
outputting, by the controller, one or more instructions to activate the at least one actuator based on the at least one predictive disturbance input; and
actuating the at least one actuator in accordance with the one or more instructions to alter the at least one dynamic vibration characteristic of the payload.
   39. The method of claim 38, wherein the at least one actuator is mounted in parallel with at least one spring-and-damper system.
   40. The method of claim 38 or 39, wherein the controller actuates the at least one actuator in accordance with the one or more instructions.
   41. The method of any of claims 38 to 40, further comprising transmitting, by the controller, the one or more instructions to a user.
   42. The method of any of claims 38 to 41, wherein actuating the at least one actuator in accordance with the one or more instructions further comprises actuating the at least one actuator to displace the payload.
   43. The method of any of claims 38 to 42, wherein actuating the at least one actuator in accordance with the one or more instructions further comprises actuating the at least one actuator to exert a force or moment on the payload.
   44. The method of any of claims 38 to 43, wherein the at least one predictive disturbance input comprises data received from at least one sensor located on one or more of the payload, the at least one payload-receiving fixture, or the aircraft.
   45. The method of any of claims 38 to 44, wherein the predictive disturbance input comprises one or more of a payload displacement, payload acceleration, payload-receiving fixture acceleration, airframe acceleration, aircraft instruction from a pilot, aircraft instruction from an electronic flight control system, atmospheric turbulence data, runway roughness, or wind gust data.
   46. The method of any of claims 38 to 45, wherein the controller includes closed-loop feedback logic.
   47. The method of any of claims 38 to 45, wherein the controller includes feedforward logic.
   48. The method of any of claims 38 to 45, wherein the controller includes closed-loop feedback logic and feedforward logic.
   49. The method of any of claims 38 to 48, further comprising processing, by the controller, the predictive disturbance input using one or more gains to generate the at least one instruction.
   50. The method of claim 49, further comprising tuning the one or more gains based on whether the aircraft is in flight, landing, or performing ground operations.
   51. The method of claim 49 or 50, further comprising tuning the one or more gains to particular characteristics of a particular payload.
   52. The method of any of claims 49 to 51, further comprising tuning the one or more gains during operation of the aircraft based on a dynamic response of the payload.
   53. The method of any of claims 36 to 52, wherein the cargo aircraft has an interior cargo bay with a forward bay portion located in a forward end of the cargo aircraft and an aft bay portion located in an aft end of the cargo aircraft.
   54. The method of claim 53, wherein the interior cargo bay of the cargo aircraft further comprises a kinked bay portion disposed between the forward bay portion and the aft bay portion, the kinked bay portion defining a location at which the aft end of the cargo aircraft begins to raise relative to a longitudinal-lateral plane of the cargo aircraft.
   55. The method of 53, wherein the one or more payload-receiving fixtures are configured to couple to the airframe within the interior cargo bay such that the payload extends from the forward bay portion, through the kinked bay portion, and into the aft bay portion of the interior cargo bay.
   56. The method of any of claims 36 to 55, wherein the one or more payload-receiving fixtures includes a plurality of payload-receiving fixtures placed with respect to the payload to minimize the dynamic load exerted on the payload.
   57. The method of any of claims 36 to 56, wherein the at least one payload-receiving fixture includes a plurality of payload-receiving fixtures placed with respect to the payload to at least one of reduce payload deflection or prevent the payload from vibrating at a nature vibration frequency of the payload.
   58. The method of any of claims 36 to 56, wherein the payload comprises at least one elongate member that exhibits natural vibration frequencies within a range of frequency typically experienced by a cargo aircraft during at least one of flight, landing, or ground operations.
   59. The method of any of claims 36 to 58, wherein the payload comprises one or more components of a wind turbine.

1. A system for alleviating dynamic loads on a payload, comprising:
at least one payload-receiving fixture configured to receive a payload and couple the payload to an airframe within an interior cargo bay of an aircraft; and
a dynamic load reduction system including at least one suspension element associated with at least one of the payload or the at least one payload-receiving fixture, the dynamic load reduction system configured to alter at least one dynamic vibration characteristic of the payload when the payload is associated with the at least one payload-receiving fixture and coupled to the airframe such that a dynamic load exerted by the airframe on the payload is reduced.

2. The system of claim 1, wherein the at least one dynamic vibration characteristic is one or more of a vibration frequency, a vibration mode shape, a vibration amplitude, or a vibration damping.

3-7. (canceled)

8. The system of claim 1,
wherein the at least one suspension element comprises at least one actuator, and
wherein the dynamic load reduction system further comprises a controller configured to:
receive at least one predictive disturbance input; and
output, based on the at least one predictive disturbance input, one or more instructions to activate the at least one actuator in response to an expected dynamic load on the payload.

9. The system of claim 8, wherein the at least one actuator comprises a linear actuator.

10. The system of claim 8, wherein the one or more instructions output by the controller instructs the at least one actuator to at least one of displace the payload or exert a force on the payload.

11. The system of claim 8, wherein the controller is further configured to actuate the at least one actuator in accordance with the at least one instruction.

12. The system of claim 8, wherein the controller is further configured to transmit the at least one instruction to a user.

13. The system of claim 8, wherein the controller is integrated into one or more payload-receiving fixtures of the at least one payload-receiving fixture.

14. The system of claim 8, further comprising a cargo aircraft,
wherein the controller is integrated into a control system of the cargo aircraft.

15. The system of claim 8, wherein the at least one predictive disturbance input is received from at least one sensor located on one or more of the payload, the at least one payload-receiving fixture, or the aircraft.

16. The system of claim 8, wherein the at least one predictive disturbance input comprises one or more of a payload displacement, payload acceleration, payload-receiving fixture acceleration, airframe acceleration, aircraft instruction from a pilot, aircraft instruction from an electronic flight control system, atmospheric turbulence data, runway roughness, or wind gust data.

17. The system of claim 16:
wherein the at least one predictive disturbance input includes at least one of the aircraft instruction from the pilot or the aircraft instruction from the electronic flight system, and
wherein the aircraft instruction from the pilot or the aircraft instruction from the electronic flight system pertains to at least one of an aircraft operation or environmental condition capable of causing an external disturbance to the payload.

18. The system of claim 8, wherein the controller comprises a feedforward controller, a feedback controller, or a combination thereof.

19. The system of claim 8, wherein the controller is configured to process the at least one predictive disturbance inputs through one or more gains to generate the at least one instruction.

20-23. (canceled)

24. The system of claim 1, wherein the at least one suspension element of the dynamic load reduction system comprises a spring-and-damper system coupled to one payload-receiving fixture of the at least one payload-receiving fixture and configured to couple to the payload received therein.

25-29. (canceled)

30. The system of claim 1, wherein the dynamic load reduction system is configured to be tuned to alter the at least one dynamic vibration characteristic of the payload based on a particular phase of aircraft operation.

31. The system of claim 30, wherein the particular phase of aircraft operation is one of in-flight, landing, or ground operations.

32. The system of claim 1, wherein the dynamic load reduction system is configured to be tuned to alter the at least one dynamic vibration characteristic of the payload based on at least one of a particular type or characteristic of a payload.

33. The system of claim 1, further comprising a cargo aircraft having an interior cargo bay with a forward bay portion located in a forward end of the cargo aircraft, an aft bay portion located in an aft end of the cargo aircraft, and a kinked bay portion disposed between the forward bay portion and the aft bay portion, the kinked bay portion defining a location at which the aft end of the cargo aircraft begins to raise relative to a longitudinal-lateral plane of the cargo.

34. (canceled)

35. (canceled)

36. A method of managing a payload within an interior cargo bay of a cargo aircraft, comprising:
altering at least one dynamic vibration characteristic of a payload coupled to an airframe of the cargo aircraft by way of one or more payload-receiving fixtures within an interior cargo bay of the cargo aircraft,
wherein altering the at least one dynamic characteristic of the payload occurs in response to a dynamic load being exerted by the airframe on the payload while the aircraft is at least one of in flight, landing, or performing ground operations.

37. The system of claim 36, wherein the at least one dynamic vibration characteristic is one or more of a vibration frequency, a vibration mode shape, a vibration amplitude, or a vibration damping.

38. The method of claim 36, wherein the cargo aircraft further comprises at least one actuator associated with at least one of the payload or at least one payload-receiving fixture of the one or more payload-receiving fixtures, and wherein the method further comprises:
receiving, by a controller, at least one predictive disturbance input from one or more sensors;
outputting, by the controller, one or more instructions to activate the at least one actuator based on the at least one predictive disturbance input; and
actuating the at least one actuator in accordance with the one or more instructions to alter the at least one dynamic vibration characteristic of the payload.

39. The method of claim 38, wherein the at least one actuator is mounted in parallel with at least one spring-and-damper system.

40. The method of claim 38, wherein the controller actuates the at least one actuator in accordance with the one or more instructions.

41. The method of claim 38, further comprising transmitting, by the controller, the one or more instructions to a user.

42. The method of claim 38, wherein actuating the at least one actuator in accordance with the one or more instructions further comprises actuating the at least one actuator to displace the payload.

43. The method of claim 38, wherein actuating the at least one actuator in accordance with the one or more instructions further comprises actuating the at least one actuator to exert a force or moment on the payload.

44. The method of claim 38, wherein the at least one predictive disturbance input comprises data received from at least one sensor located on one or more of the payload, the at least one payload-receiving fixture, or the aircraft.

45. The method of claim 38, wherein the at least one predictive disturbance input comprises one or more of a payload displacement, payload acceleration, payload-receiving fixture acceleration, airframe acceleration, aircraft instruction from a pilot, aircraft instruction from an electronic flight control system, atmospheric turbulence data, runway roughness or wind gust data.

46. The method of claim 38, wherein the controller includes closed-loop feedback logic.

47. The method of claim 38, wherein the controller includes feedforward logic.

48. The method of claim 38, wherein the controller includes closed-loop feedback logic and feedforward logic.

49. The method of claim 38, further comprising processing, by the controller, the at least one predictive disturbance input using one or more gains to generate the at least one instruction.

50-52. (canceled)

53. The method of claim 36, wherein the cargo aircraft has an interior cargo bay with a forward bay portion located in a forward end of the cargo aircraft, an aft bay portion located in an aft end of the cargo aircraft, and a kinked bay portion disposed between the forward bay portion and the aft bay portion, the kinked bay portion defining a location at which the aft end of the cargo aircraft begins to raise relative to a longitudinal-lateral plane of the cargo aircraft.

54-57. (canceled)

58. The method of claim 36, wherein the payload comprises at least one elongate member that exhibits natural vibration frequencies within a range of frequency typically experienced by a cargo aircraft during at least one of flight, landing, or ground operations.

59. The method of claim 36, wherein the payload comprises one or more components of a wind turbine.
